(19) United States
(12) Patent Application Publication
(10) Pub. No.: US 2025/0184172 A1
(43) Pub. Date: Jun. 5, 2025

(54) NETWORK NODES AND METHODS THEREIN FOR FACILITATING MANAGEMENT OF MULTICAST/BROADCAST SERVICE SESSION

(71) Applicant: Telefonaktiebolaget LM Ericsson (publ), Stockholm (SE)

(72) Inventors: Jie LING, Shanghai (CN); Juying GAN, Shanghai (CN); Yong YANG, Kållered (SE)

(73) Assignee: Telefonaktiebolaget LM Ericsson (publ), Stockholm (SE)

(21) Appl. No.: 18/725,754

(22) PCT Filed: Dec. 28, 2022
(86) PCT No.: PCT/CN2022/142671

§ 371 Date: Jun. 28, 2024

(30) Foreign Application Priority Data
Dec. 31, 2021 (WO) PCT/CN2021/143933

(51) Int. Cl. H04L 12/18; H04W 72/30; H04W 76/32; H04W 76/40

(52) U.S. Cl. CPC H04L 12/1868; H04W 72/30; H04W 76/32; H04W 76/40

(57) ABSTRACT

A method in a Multicast/Broadcast Session Management Function (MB-SMF), in which the method includes receiving, from an Access and Mobility Management Function (AMF), an identifier (ID) of a Next Generation-Radio Access Network (NG-RAN) and an indication of restart or failure of the NG-RAN.

### CROSS-REFERENCE TO RELATED APPLICATION(S)

This application claims priority to the PCT International Application No. PCT/CN2021/143933, entitled “NETWORK NODES AND METHODS THEREIN FOR FACILITATING MANAGEMENT OF MULTICAST/BROADCAST SERVICE SESSION”, filed on Dec. 31, 2021, which is incorporated herein by reference in its entirety.

### TECHNICAL FIELD

The present disclosure relates to communication technology, and more particularly, to network nodes and methods therein for facilitating management of a Multicast/Broadcast Service (MBS) session.

### BACKGROUND

Broadcast MBS session refers to an MBS session to deliver the broadcast communication service. A broadcast MBS session is characterized by the content to send and the geographical area where to distribute it.

The 3rd Generation Partnership Project (3GPP) Technical Specification (TS) 23.247, v17.0.0, which is incorporated herein by reference in its entirety, specifies architectural enhancements to the 5th Generation (5G) system using New Radio (NR) to support multicast and broadcast communication services.

Overview of Multicast and Broadcast Communication MBS is a point-to-multipoint service in which data is transmitted from a single source entity to multiple recipients, either to all users in a broadcast service area, or to users in a multicast group. The corresponding types of MBS session are:
Broadcast session; and
Multicast session.

The MBS architecture follows the 5G System (5GS) architectural principles, enabling distribution of the MBS data from the 5GS ingress to Next Generation-Radio Access Network (NG-RAN) node(s) and then to the User Equipment (UE). The MBS architecture provides:
Efficient usage of RAN and Core Network (CN) resources, with an emphasis on radio interface efficiency;
Efficient transport for a variety of multicast and broadcast services.

The 5G MBS also provides functionalities such as local MBS service, authorization of multicast MBS and Quality of Service (QOS) differentiation.

MBS traffic is delivered from a single data source (e.g. Application Service Provider) to multiple UEs. Depending on many factors, there are several delivery methods which may be used to deliver the MBS traffic in the 5GS.

Between 5G Core (5GC) and NG-RAN, there are two possible delivery methods to transmit the MBS data:
5GC Individual MBS traffic delivery method: This method is only applied for multicast MBS session. 5GC receives a single copy of MBS data packets and delivers separate copies of those MBS data packets to individual UEs via per-UE Protocol Data Unit (PDU) sessions, hence for each such UE one PDU session is required to be associated with a multicast session.
5GC Shared MBS traffic delivery method: This method is applied for both broadcast and multicast MBS session. 5GC receives a single copy of MBS data packets and delivers a single copy of those MBS packets to an NG-RAN node, which then delivers the packets to one or multiple UEs.

The 5GC Shared MBS traffic delivery method is required in all 5G MBS deployments. The 5GC Individual MBS traffic delivery method is required to enable mobility when there is an NG-RAN deployment with non-homogeneous support of 5G MBS.

For the multicast session, a single copy of MBS data packets received by the CN may be delivered via 5GC Individual MBS traffic delivery method for some UE(s) and via 5GC Shared MBS traffic delivery method for other UEs.

Between the NG-RAN and the UE, two delivery methods are available for the transmission of MBS data packets over radio interface:
Point-to-Point (PTP) delivery method: NG-RAN delivers separate copies of MBS data packets over radio interface to individual UE(s).
Point-to-Multipoint (PTM) delivery method: NG-RAN delivers a single copy of MBS data packets over radio interface to multiple UEs.

NG-RAN may use a combination of PTP/PTM to deliver an MBS data packets to UEs.

FIG. 1 illustrates delivery methods for MBS multicast/broadcast communication. As depicted in FIG. 1, 5GC Shared MBS traffic delivery method (with PTP or PTM delivery) and 5GC Individual MBS traffic delivery method may be used at the same time for a multicast MBS session.

For MBS broadcast communication, only 5GC Shared MBS traffic delivery method with PTM delivery is applicable.

For MBS multicast communication, if the NG-RAN node supports 5G MBS, the network shall use the 5GC Shared MBS traffic delivery method for MBS data transmission.

For MBS multicast communication, the switching between 5GC Shared MBS traffic delivery method and 5GC Individual MBS traffic delivery method is supported. The UE mobility between RAN nodes both supporting MBS, and between a RAN node supporting MBS and a RAN node not supporting MBS is supported.

For MBS multicast communication, the switching between PTP and PTM delivery methods for 5GC Shared MBS traffic delivery shall be supported. NG-RAN is the decision point for switching between PTP and PTM delivery methods.

### System Architecture for MBS

FIG. 2 illustrates 5G system architecture for MBS. Service-based interfaces are used within the Control Plane. FIG. 3 illustrates 5G system architecture for MBS in reference point representation. For details of the functions and interfaces/reference points in the 5G system architecture, reference can be made to TS 23.247, v17.0.0, and description thereof will be omitted here.

### SUMMARY

It is an object of the present disclosure to provide network nodes and methods therein for facilitating management of an MBS session.

According to a first aspect of the present disclosure, a method in a Multicast/Broadcast Session Management Function (MB-SMF) is provided. The method includes: receiving, from an Access and Mobility Management Function (AMF), an ID of an NG-RAN and an indication of restart or failure of the NG-RAN.

In an embodiment, an ID of a Multicast/Broadcast Service, MBS, session associated with the NG-RAN may be received together with the ID of the NG-RAN and the indication of restart or failure of the NG-RAN.

In an embodiment, the ID of the NG-RAN, the indication of restart or failure of the NG-RAN, and the ID of the MBS session may be contained in an MBS broadcast context status notify request.

In an embodiment, the method may further include, prior to the operation of receiving: receiving, from the AMF in a start or update procedure for the MBS session, a message containing the ID of the NG-RAN.

In an embodiment, the ID of the NG-RAN may be contained in an N2 Session Management (SM) information container or is carried outside the N2 SM information container.

In an embodiment, the message may further contain tunnel information of a DL tunnel for the MBS session. In an embodiment, the tunnel information may be contained in the N2 SM information container. In an embodiment, the method may further include: maintaining a mapping between the ID of the NG-RAN and the tunnel information.

In an embodiment, the method may further include: transmitting, to an MB-UPF, in response to receiving the indication, a session modification request to release the DL tunnel corresponding to the NG-RAN. In an embodiment, the session modification request may contain the ID of the MBS session and the tunnel information.

In an embodiment, the method may further include, in response to receiving the indication of restart of the NG-RAN: transmitting, to the AMF, a request to restore the MBS session towards the NG-RAN. In an embodiment, the request may contain the ID of the NG-RAN and the ID of the MBS session.

In an embodiment, the request may be an MBS Broadcast Context Update request or an MBS Broadcast Context Create request.

In an embodiment, the request may further contain an indication of MBS session restoration.

In an embodiment, the method may further include: receiving, from the AMF, a response to the request to restore the MBS session, or an MBS broadcast context status notify request. In an embodiment, the response or the MBS broadcast context status notify request may contain the ID of the NG-RAN.

In an embodiment, the response or the MBS broadcast context status notify request may further contain tunnel information of another DL tunnel for the MBS session. In an embodiment, the method may further include: maintaining a mapping between the ID of the NG-RAN and the tunnel information of the other DL tunnel.

According to a second aspect of the present disclosure, a method in an MB-SMF is provided. The method includes: receiving, from an Multicast/Broadcast User Plane Function (MB-UPF), a report indicating: an error associated with tunnel information of a DL tunnel for a Packet Filter Control Protocol (PFCP) session, or a failure or restart associated with an Internet Protocol (IP) address in the tunnel information or a transport network IP address. The method further includes: identifying an NG-RAN corresponding to the tunnel information, the IP address in the tunnel information, or the transport network IP address. The method includes: transmitting, to an AMF, a request to restore an MBS session corresponding to the PFCP session, the IP address in the tunnel information, or the transport network IP address towards the NG-RAN. The request contains an ID of the NG-RAN and an ID of the MBS session.

In an embodiment, the report may be a PFCP session report or a node-level report.

In an embodiment, the method may further include, prior to the operation of receiving: receiving, from the AMF in a start or update procedure for the MBS session, a message containing the ID of the NG-RAN.

In an embodiment, the ID of the NG-RAN may be contained in an N2 SM information container or be carried outside the N2 SM information container.

In an embodiment, the message may further contain the tunnel information or the transport network IP address.

In an embodiment, the method may further include: maintaining a mapping between the ID of the NG-RAN and the tunnel information, the IP address in the tunnel information, or the transport network IP address.

In an embodiment, the method may further include: signaling, to the MB-UPF, the tunnel information or the transport network IP address.

In an embodiment, the method may further include: receiving, from the AMF, a response to the request to restore the MBS session, or an MBS broadcast context status notify request, the response or the MBS broadcast context status notify request containing the ID of the NG-RAN.

In an embodiment, the response or the MBS broadcast context status notify request may further contain tunnel information of another DL tunnel or another transport network IP address corresponding to the NG-RAN.

In an embodiment, the method may further include: maintaining a mapping between the ID of the NG-RAN and the tunnel information of the other DL tunnel, an IP address in the tunnel information of the other DL tunnel, or the other transport network IP address.

In an embodiment, the transport network IP address may be an IP address for user plane path management.

In an embodiment, the request to restore the MBS session may be an MBS Broadcast Context Update request or an MBS Broadcast Context Create request.

In an embodiment, the request to restore the MBS session may further contain an indication of MBS session restoration.

According to a third aspect of the present disclosure, a method in an AMF is provided. The method includes: receiving, from an MB-SMF, a request to restore an MBS session towards an NG-RAN. The request contains an ID of the NG-RAN.

In an embodiment, the request may further contain an ID of the MBS session.

In an embodiment, the method may further include, prior to the operation of receiving, in a start or update procedure for the MBS session: transmitting, to the MB-SMF, another message containing the ID of the NG-RAN. In an embodiment, the ID of the NG-RAN may be contained in an N2 SM information container.

In an embodiment, the message may further contain tunnel information of a DL tunnel corresponding to the NG-RAN. In an embodiment, the other message may further contain the tunnel information. In an embodiment, the tunnel information may be contained in the N2 SM information container.

In an embodiment, the method may further include, prior to the operation of receiving, in a start or update procedure for the MBS session: transmitting, to the MB-SMF, a message containing the ID of the NG-RAN. In an embodiment, the ID of the NG-RAN may be carried outside an N2 SM information container.

In an embodiment, the method may further include: receiving, from the NG-RAN, another message containing tunnel information of a DL tunnel corresponding to the NG-RAN. In an embodiment, the message may further contain the tunnel information. In an embodiment, the tunnel information may be contained in the N2 SM information container.

In an embodiment, the method may further include, subsequent to receiving the request to restore the MBS session: transmitting, to the NG-RAN, a request to set up resources for the MBS session; receiving, from the NG-RAN, a response to the request to set up resources for the MBS session; and transmitting, to the MB-SMF, a response to the request to restore the MBS session, or an MBS broadcast context status notify request. In an embodiment, the response or the MBS broadcast context status notify request may contain the ID of the NG-RAN.

In an embodiment, the method may further include, prior to receiving the request to restore the MBS session: transmitting, to the MB-SMF, the ID of the NG-RAN, an indication of restart of the NG-RAN, and the ID of the MBS session.

In an embodiment, the ID of the NG-RAN, the indication of restart of the NG-RAN, and the ID of the MBS session may be contained in an MBS broadcast context status notify request.

In an embodiment, the method may further include, prior to transmitting the indication of restart of the NG-RAN: receiving, from the NG-RAN, an NG setup request or NG reset request indicating the restart of the NG-RAN; and determining the ID of the MBS session associated with the NG-RAN.

In an embodiment, the message may further contain tunnel information of a DL tunnel or a transport network IP address corresponding to the NG-RAN. In an embodiment, the other message may further contain the tunnel information or the transport network IP address. In an embodiment, the tunnel information or the transport network IP address may be contained in the N2 SM information container.

In an embodiment, the method may further include: receiving, from the NG-RAN, another message containing tunnel information of a DL tunnel or a transport network IP address corresponding to the NG-RAN. In an embodiment, the message may further contain the tunnel information or the transport network IP address. In an embodiment, the tunnel information or the transport network IP address may be contained in the N2 SM information container.

In an embodiment, the method may further include, subsequent to receiving the request to restore the MBS session: transmitting, to the NG-RAN, a request to set up resources for the MBS session; receiving, from the NG-RAN, a response to the request to set up resources for the MBS session, the response containing the ID of the NG-RAN and tunnel information of another DL tunnel or another transport network IP address corresponding to the NG-RAN; and transmitting, to the MB-SMF, a response to the request to restore the MBS session, or an MBS broadcast context status notify request, the response or the MBS broadcast context status notify request containing the ID of the NG-RAN and the tunnel information of the other DL tunnel or the other transport network IP address corresponding to the NG-RAN.

In an embodiment, the transport network IP address may be an IP address for user plane path management.

In an embodiment, the request to restore the MBS session may be an MBS Broadcast Context Update request or an MBS Broadcast Context Create request.

In an embodiment, the request to restore the MBS session may further contain an indication of MBS session restoration.

According to a fourth aspect of the present disclosure, a method in an AMF is provided. The method includes: transmitting, to an MB-SMF, an ID of an NG-RAN and an indication of failure of the NG-RAN.

In an embodiment, an ID of a Multicast/Broadcast Service, MBS, session associated with the NG-RAN may be transmitted together with the ID of the NG-RAN and the indication of failure of the NG-RAN.

In an embodiment, the ID of the NG-RAN, the indication of failure of the NG-RAN, and the ID of the MBS session may be contained in an MBS broadcast context status notify request.

In an embodiment, the method may further include, prior to the operation of transmitting: detecting the failure of the NG-RAN using a Stream Control Transmission Protocol (SCTP).

In an embodiment, the method may further include, prior to the operation of transmitting, in a start or update procedure for the MBS session: receiving, from the NG-RAN, a message containing the ID of the NG-RAN; and transmitting, to the MB-SMF, another message containing the ID of the NG-RAN. In an embodiment, the ID of the NG-RAN may be contained in an N2 SM information container.

In an embodiment, the message may further contain tunnel information of a DL tunnel corresponding to the NG-RAN. In an embodiment, the other message may further contain the tunnel information. In an embodiment, the tunnel information may be contained in the N2 SM information container.

In an embodiment, the method may further include, prior to the operation of transmitting, in a start or update procedure for the MBS session: transmitting, to the MB-SMF, a message containing the ID of the NG-RAN. In an embodiment, the ID of the NG-RAN may be carried outside an N2 SM information container.

In an embodiment, the method may further include: receiving, from the NG-RAN, another message containing tunnel information of a DL tunnel corresponding to the NG-RAN. In an embodiment, the message may further contain the tunnel information. In an embodiment, the tunnel information may be contained in the N2 SM information container.

According to a fifth aspect of the present disclosure, a method in an MB-UPF is provided. The method includes: receiving, from an MB-SMF, tunnel information of a DL tunnel or a transport network IP address associated with an MBS session. The method further includes: transmitting, to an MB-SMF, a report indicating an error associated with the tunnel information for a PFCP session corresponding to the MBS session, or a failure or restart associated with an IP address in the tunnel information or the transport network IP address.

In an embodiment, the report may be a PFCP session report or a node-level report.

In an embodiment, the method may further include, prior to the operation of transmitting: transmitting, to an NG-RAN, a packet based on the tunnel information; and receiving, from the NG-RAN, the indication indicating the error.

In an embodiment, the method may further include: receiving, from the MB-SMF, a session modification request to release the DL tunnel corresponding to the NG-RAN. In an embodiment, thee session modification request may contain an ID of the MBS session and the tunnel information.

In an embodiment, the method may further include, subsequent to the operation of receiving and prior to the operation of transmitting: transmitting a request for user plane path management to the IP address in the tunnel information or the transport network IP address; and receiving, from the IP address in the tunnel information or the transport network IP address, a response containing information from which the restart is derivable, or determining the failure in response to receiving no response to the request from the IP address in the tunnel information or the transport network IP address for a predetermined time period.

In an embodiment, the request for user plane path management may be a General Packet Radio Service (GPRS) Tunnel Protocol-User Plane (GTP-U) echo request. In an embodiment, the response may be a GTP-U echo response.

In an embodiment, the transport network IP address may be an IP address for user plane path management.

According to a sixth aspect of the present disclosure, a method in an NG-RAN is provided. The method includes: receiving, from the AMF, a request to set up resources for the MBS session. The method further includes: transmitting, to an AMF, a response to the request to set up resources for the MBS session. The response contains an ID of the NG-RAN and/or a transport network IP address corresponding to the NG-RAN.

In an embodiment, the ID of the NG-RAN and/or the transport network IP address is contained in an N2 SM information container.

According to a seventh aspect of the present disclosure, a network node is provided. The network node includes a communication interface, a processor and a memory. The memory includes instructions executable by the processor whereby the network node is operative to, when implementing an MB-SMF, perform the method according to the first or second aspect, or when implementing an AMF, perform the method according to the third or fourth aspect, or when implementing an MB-UPF, perform the method according to the fifth aspect, or when implementing an NG-RAN, perform the method according to the sixth aspect.

According to an eighth aspect of the present disclosure, a computer-readable storage medium is provided. The computer readable storage medium has computer-readable instructions stored thereon. The computer-readable instructions, when executed by a processor of a network node, configure the network node to, when implementing an MB-SMF, perform the method according to the first or second aspect, or when implementing an AMF, perform the method according to the third or fourth aspect, or when implementing an MB-UPF, perform the method according to the fifth aspect, or when implementing an NG-RAN, perform the method according to the sixth aspect.

With the embodiments of the present disclosure, an MBS session that is lost due to restart or failure of an NG-RAN can be restored, so that one or more UEs within the coverage of the NG-RAN are able to receive the corresponding MBS service.

### BRIEF DESCRIPTION OF THE DRAWINGS

The above and other objects, features and advantages will be more apparent from the following description of embodiments with reference to the figures, in which:

FIG. 1 illustrates delivery methods for MBS multicast/broadcast communication;

FIG. 2 illustrates 5G system architecture for MBS;

FIG. 3 illustrates 5G system architecture for MBS in reference point representation;

FIG. 4 schematically illustrates user plane data transmission;

FIG. 5 is a sequence chart illustrating an exemplary process of restoring a PDU session in a 5G system;

FIG. 6 is a flowchart illustrating a method in an MB-SMF according to an embodiment of the present disclosure;

FIG. 7 is a flowchart illustrating a method in an MB-SMF according to another embodiment of the present disclosure;

FIG. 8 is a flowchart illustrating a method in an AMF according to an embodiment of the present disclosure;

FIG. 9 is a flowchart illustrating a method in an AMF according to another embodiment of the present disclosure;

FIG. 10 is a flowchart illustrating a method in an MB-UPF according to an embodiment of the present disclosure;

FIG. 11 is a flowchart illustrating a method in an NG-RAN according to an embodiment of the present disclosure;

FIG. 12 is a sequence chart illustrating an exemplary MBS session start process for a broadcast MBS session according to an embodiment of the present disclosure;

FIG. 13 is a sequence chart illustrating an exemplary process of restoring an MBS session according to an embodiment of the present disclosure;

FIG. 14 is a sequence chart illustrating an exemplary process of handling an NG-RAN failure according to another embodiment of the present disclosure;

FIG. 15 is a sequence chart illustrating an exemplary MBS session start process for a broadcast MBS session according to another embodiment of the present disclosure;

FIG. 16 is a sequence chart illustrating an exemplary process of restoring an MBS session according to another embodiment of the present disclosure;

FIG. 17 is a sequence chart illustrating an exemplary process of restoring an MBS session according to another embodiment of the present disclosure;

FIG. 18 is a block diagram of a network node according to an embodiment of the present disclosure;

FIG. 19 is a block diagram of a network node according to another embodiment of the present disclosure;

FIG. 20 is a block diagram of a network node according to another embodiment of the present disclosure;

FIG. 21 is a block diagram of a network node according to another embodiment of the present disclosure;

FIG. 22 is a block diagram of a network node according to another embodiment of the present disclosure;

FIG. 23 is a block diagram of a network node according to another embodiment of the present disclosure; and

FIG. 24 is a block diagram of a network node according to another embodiment of the present disclosure.

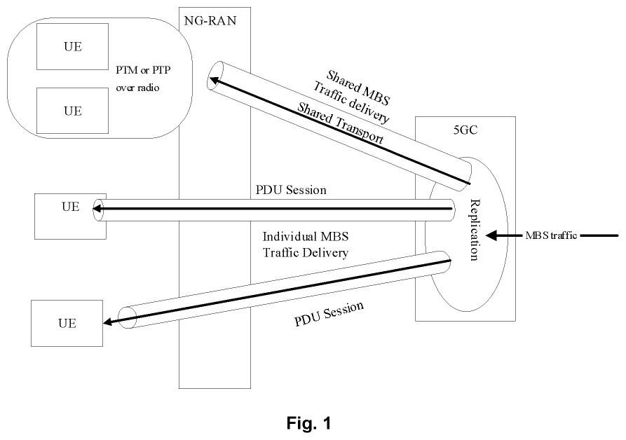

### DETAILED DESCRIPTION

As used herein, a network function can be implemented either as a network element on a dedicated hardware, as a software instance running on a dedicated hardware, or as a virtualized function instantiated on an appropriate platform, e.g. on a cloud infrastructure.

In the following, references in the specification to “one embodiment”, “an embodiment”, “an example embodiment” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In the following description and claims, unless defined otherwise, all technical and scientific terms used herein have the same meaning as commonly understood by one of ordinary skills in the art to which this disclosure belongs.

### Transport Over N3mb Between NG-RAN and MB-UPE

Per TS 23.247, v17.0.0, unicast or multicast transport over N3mb between NG-RAN and MB-UPF may be applied:
If unicast transport over N3mb is applied, each NG-RAN allocates Tunnel Information (including an IP address and a Tunnel Endpoint Identifier (TEID)) which is provided to MB-UPF (via an Access and Mobility Management Function (AMF), Multicast/Broadcast Session Management Function (MB-SMF)) so that the Downlink (DL) MBS packet can be sent to that tunnel entity.
If multicast transport over N3mb is applied, the NG-RAN does not provide Tunnel Information. Instead, the NG-RAN joins a multicast IP address provided by the MB-UPF.

FIG. 4 schematically illustrates user plane data transmission. The MB-UPF acts as the MBS Session Anchor of an MBS session, and if the MBSTF is involved in the MBS session, then the MBSTF acts as the media anchor of the MBS traffic. The MB-UPF receives only one copy of MBS data packets from Application Function (AF) or Multicast/Broadcast Service Transport Function (MBSTF).

The user plane between MBSTF and MB-UPF, or between MB-UPF and AF, may use either multicast transport or unicast tunnel for the MBS session (depending on application and capabilities of control interface). If the transport network does not support multicast transport, the user plane uses unicast tunnel for the MBS Session. The user plane between MBSTF and AF may use unicast tunnel, multicast transport or other means (e.g., Hyper Text Transfer Protocol (HTTP) download from external Content Delivery Network (CDN)). If unicast is used for the MBS Session, after receiving the downlink MBS data, the MB-UPF forwards the downlink MBS data without the outer IP header and tunnel header information.

The user plane from the MB-UPF to NG-RAN(s) (for shared delivery) and the user plane from the MB-UPF to UPFs (for individual delivery) may use multicast transport via a common GTP-U tunnel per MBS session, or use unicast transport via separate General Packet Radio Service (GPRS) Tunnel Protocol-User Plane (GTP-U) tunnels at NG-RAN or at UPF per MBS session. If the user plane uses unicast transport, the transport layer destination is the IP address of the NG-RAN or UPF, each NG-RAN or UPF allocates the tunnel separately and multiple GTP-U tunnels are used for the MBS Session. If the user plane uses multicast transport, a common GTP-U tunnel is used for both RAN and UPF nodes. The GTP-U tunnel is identified by a common tunnel identifier (ID) and an IP multicast address as the transport layer destination, both assigned by 5GC.

The MB-SMF configures the MB-UPF to receive packets related to an MBS session.

For shared delivery, if unicast transport over N3mb applies, the MB-SMF configures MB-UPF to replicate the received MBS packets and forward them towards multiple RAN nodes via separate GTP tunnel. For shared delivery, if multicast transport over N3mb applies, the MB-SMF configures the MB-UPF to replicate the received MBS data and forwards the data via a single GTP tunnel. For individual delivery, the MBS data received by the MB-UPF is replicated towards the UPF(s) where individual delivery is performed in the following way:
The MB-SMF configures the MB-UPF to receive packets related to an MBS session, to replicate those packets and forward them towards multiple UPFs via GTP tunnels if unicast transport over N19mb is applied, or via a single GTP tunnel if multicast transport over N19mb is applied.
The SMF(s) configures the UPF to receive packets related to a multicast session from an MB-UPF over N19mb, to replicate those packets and to forward them in multiple PDU sessions.

For the SMF and the UPF (for 5GC individual delivery), packet detection, replication and forwarding for an MBS session is realized by Packet Detection Rule (PDR) and Forwarding Action Rule (FAR) of the PDU session in which the UE has joined the MBS session:
The SMF instructs the UPF to associate the PFCP session of the PDU session with an MBS session.
A new PDR with Source Interface “Core” is used to detect MBS data from N19mb.

NOTE: This PDR is also containing the MBS session ID to enable a single detection of the incoming MBS data for multiple PDU sessions at the UPF.
For unicast transport over N19mb, the SMF requests UPF to allocate N19mb Tunnel Info if not allocated.
For multicast transport over N19mb, the SMF includes the low layer source specific multicast address information and C-TEID to UPF.
If the SMF wants to maintain the MBS data reception over N19mb but suspends the delivery of the data to the UE's PDU session, the Action of FAR is set to “drop” (e.g. when the UE is switching from 5GC Individual delivery to 5GC Shared delivery due to the UE moving from MBS non-supporting NG-RAN to MBS supporting NG-RAN). Otherwise the SMF removes the related PDR and FAR.

See TS 29.244, V17.3.0, which is incorporated herein by reference in its entirety, for the details of user plane handling.

For the MB-SMF and MB-UPF, traffic replication and forwarding for an MBS session is realized by using for each MBS session one PDR that detects the incoming MBS packets and points to one FAR that describes the forwarding of the data towards multiple destinations (UPFs or RAN nodes):
A Packet Filter Control Protocol (PFCP) session is created when the MBS Session is started, regardless of multicast or unicast transport over N3mb and N19mb.
For Multicast transport over N3mb and N19mb, the destination in the FAR contains the MB-UPF IP Multicast Distribution Information.
For unicast transport over N3mb and N19mb, the FAR in the PFCP session may contain multiple destinations represented by the NG-RAN N3mb Tunnel Info and UPF N19mb Tunnel Info (if applicable).

### Procedures for Restoring a PDU Session in 5G System

The 3GPP TS 23.527, v17.1.0, which is incorporated herein by reference in its entirety, specifies the restoration procedures in the 5G system. It covers two scenarios, i.e., NG-RAN failure and NG-RAN restart.
Upon restart of an NG-RAN (or NG-RAN restart), where the NG-RAN will lose all session contexts, and upon receiving DL packets from the UPF towards an unknown GTP-U tunnel endpoint, it will send a GTP-U Error Indication. The UPF will then report the receiving GTP-U Error Indication to the SMF, so that the SMF can decide if to restore the MBS session in the restarted NG-RAN.
Upon an NG-RAN (partial) failure without restart or there is a user plane path between an NG-RAN and a UPF, the UP function can detect such failure using GTP-U echo request/response mechanism. That is, if the UPF doesn't receive the corresponding GTP-U echo response for an operator's configurable retry times, then the UPF will determine the failure of GTP-U path and report the failure to the SMF.

TS 23.527, v17.1.0, also specifies the procedures supported in the 5G System to detect and handle failures affecting the user plane interfaces N3 and N9.

### —Loss of GTP-U Contexts

A GTP-U entity may lose its GTP-U contexts upon a failure or restart. When a GTP-U node receives a G-PDU for which no corresponding GTP-U tunnel exists, the GTP-U node shall discard the G-PDU and return a GTP-U Error Indication to the sending node. The receipt of a GTP-U Error Indication is an indication for the sending GTP-U entity that the peer GTP-U entity cannot receive any more user plane traffic on the corresponding GTP-U tunnel.

### —User Plane Path Failure

A GTP-U entity may detect a user plane path failure by using GTP-U Echo Request and Echo Response messages.

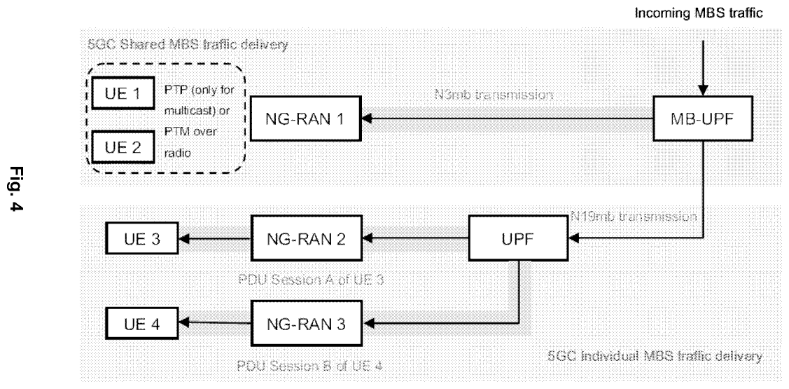

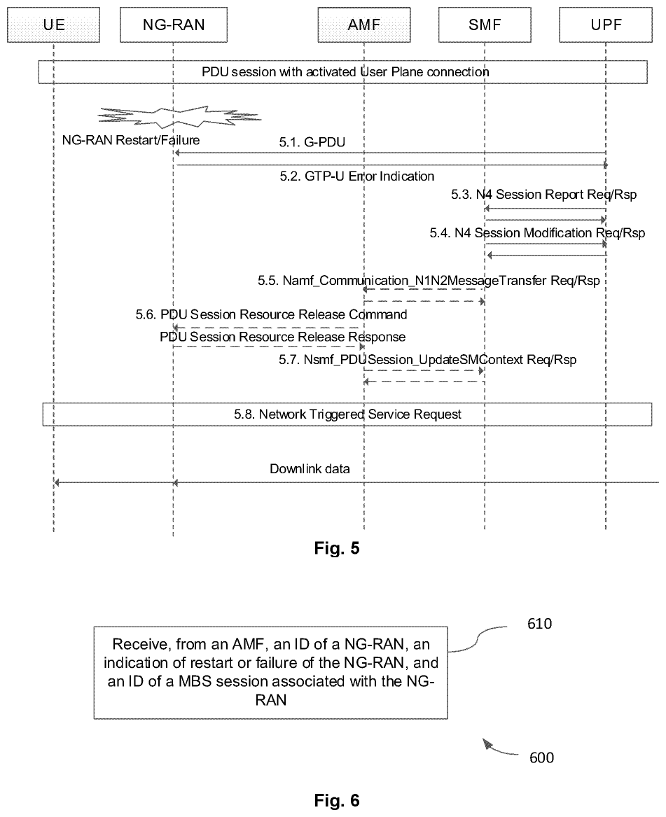

FIG. 5 is a sequence chart illustrating an exemplary process of restoring a PDU session in the 5G system. As shown, at 5.1, the user plane connection of an existing PDU session is activated. Downlink G-PDUs are sent towards the NG-RAN. At 5.2, The NG-RAN returns a GTP-U Error Indication if it does not have a corresponding GTP-U context. At 5.3, upon receipt of a GTP-U Error Indication, the UPF shall identify the related PFCP session and send an Error Indication Report to the SMF. At 5.4, for a GTP-U Error Indication received from an NG-RAN, the SMF shall modify the PFCP session to instruct the UPF to buffer downlink packets. At 5.5, if the user plane connection of the PDU session is seen as activated by the SMF, the SMF shall initiate an Namf_Communication_N1N2Message Transfer service operation to request the NG-RAN to release the PDU session's resources.

At 5.6, upon receipt of an Namf_Communication_N1N2Message Transfer request to transfer the PDU Session Resource Release Command, the AMF shall:
proceed with the request, if the UE is in CM-CONNECTED state for the Access Network Type associated to the PDU session;
otherwise, reject the request with an error indicating that the UE is in CM-IDLE state for the Access Network Type associated to the PDU session. At 5.7, if the AMF sent a PDU Session Resource Release Command to the NG-RAN, the PDU session's resource release is acknowledged to the SMF. At 5.8, the SMF initiates the Network Triggered Service Request procedure, to re-activate the user plane connection of the PDU session.

Some of the embodiments of the present disclosure provide solutions to restore an MBS Session in an NG-RAN if the MBS session is lost due to failure or restart of the NG-RAN. These solutions may include one or more of the following features:
During MBS Session Start/Update for Broadcast as specified in clauses 7.3.1 and 7.3.3 of TS 23.247, the AMF may provide the MB-SMF with an NG-RAN ID in addition to the N2 information (which is transparent to the AMF) received from the NG-RAN in the Namf_MBSBroadcast_ContextCreate Response or
Namf_MBSBroadcast_ContextNotify Request. Alternatively, the NG-RAN may include an NG-RAN ID in an N2 container which is sent to the MB-SMF via the AMF. Then, the MB-SMF may maintain a mapping between the NG-RAN ID and DL Tunnel Info (for unicast transport over N3mb) for receiving MBS session data.

### —NG-RAN Failure/Restart can be Detected Via Control Plane (CP) or User Plane (UP) as Follows:

### —CP Solution—NG-RAN Failure/Restart Detected by AMF:

1. When the AMF detects the NG-RAN restart by receiving NG Setup Request or NG Reset Request from the NG-RAN, the AMF may inform the MB-SMF, via Namf_MBSBroadcast_ContextStatusNotify, of the NG-RAN ID (e.g., NG-RAN ID and an indication that the NG-RAN is restarted) and an affected MBS session.
2. The MB-SMF, upon reception of the Namf_MBSBroadcast_ContextStatusNotify, may clean or release user plane resources towards the NG-RAN for the MBS session in the MB-UPF, by removing the DL Tunnel Info allocated by the NG-RAN before the restart.
3. The MB-SMF may restore the MBS session towards the AMF, via triggering Namf_MBSBroadcast_ContextUpdate including the NG-RAN ID and optionally an indication of “restoration”.
4. The AMF may set up MBS session resources towards the NG-RAN based on the NG-RAN ID received from the MB-SMF.
5. For unicast transport over N3mb, the NG-RAN may return new DL Tunnel Info to the AMF, which will forward the new DL Tunnel Info to the MB-SMF. The MB-SMF may then provide the new DL Tunnel Info to the MB-UPF, requesting to forward a copy of the MBS session data to the new DL tunnel endpoint.

(In the case of NG-RAN failure or N2 path failure, the AMF may detect NG-RAN failure or N2 path failure (e.g., in response to no more Transport Network Layer (TNL) associations in service), and inform the MB-SMF, via Namf_MBSBroadcast_ContextStatusNotify, of the NG-RAN ID (e.g., the NG-RAN ID and an indication of failure of the NG-RAN or N2 path) and an affected MBS session. The MB-SMF may clean user plane resources towards the NG-RAN for the MBS session in the MB-UPF, by removing the DL Tunnel Info allocated by the NG-RAN before the failure.)

### —UP Solution-NG-RAN Failure/Restart Detected by MB-UPF:

1a. For unicast transport over N3mb:
   1a—option 1: The MB-UPF may detect loss of GTP-U context in the NG-RAN (due to NG-RAN failure/restart) via a GTP-U Error Indication. The MB-UPF may inform the MB-SMF accordingly via a PFCP session report.
   1a—option 2: The MB-UPF may detect a path failure towards the NG-RAN by means of UP path management if no Echo Response is received after an Echo Request has been sent for a configurable number of times, and the MB-UPF may detect NG-RAN restart via path management (e.g., the Echo Response contains a restart counter, and the incremented value of the restart counter indicates the restart). The MB-UPF may inform the MB-SMF accordingly via a node-level report.
1b. For multicast transport over N3mb:
   1b-1: During MBS Session Start for Broadcast as specified in clause 7.3.1 of TS 23.247, when the NG-RAN determines to use multicast transport over N3mb, the NG-RAN provides an additional Transport Network IP Address of the NG-RAN to the MB-SMF and then to the MB-UPF for UP path management. This Transport Network IP Address may enable the peer GTP-U entity (i.e., the MB-UPF) to send GTP-U Echo Request and receive Echo response, so as to detect potential failure/restart of the NG-RAN.
   1b-2: When the MB-UPF detects the NG-RAN restart via UP path management (i.e., GTP-U e.g., the Echo Response contains a restart counter, and the incremented value of the restart counter indicates the restart), the MB-UPF may inform the MB-SMF accordingly via a node-level report
2. When the MB-UPF receives a GTP-U Error Indication or determines NG-RAN failure/restart by means of UP path management, the MB-UPF may inform the MB-SMF accordingly via a PFCP session report or a node report.
3. The MB-SMF may then initiate restoration of the MBS Session towards the NG-RAN in the same way as in Steps 3˜5 of the CP solution as described above.

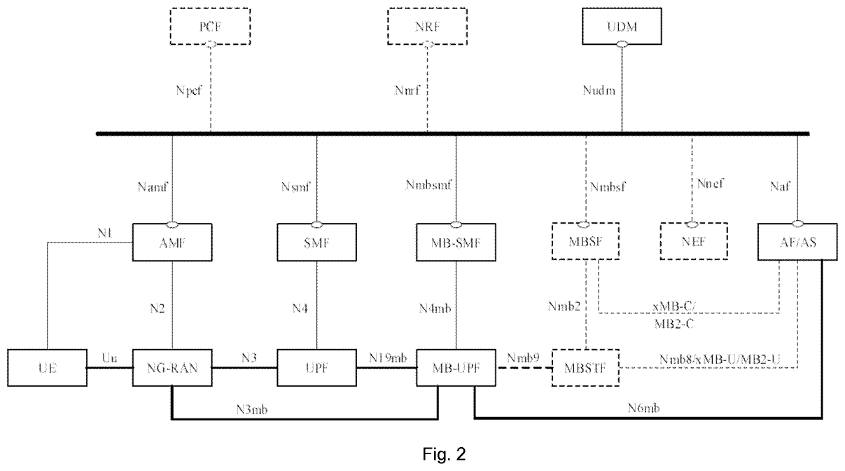

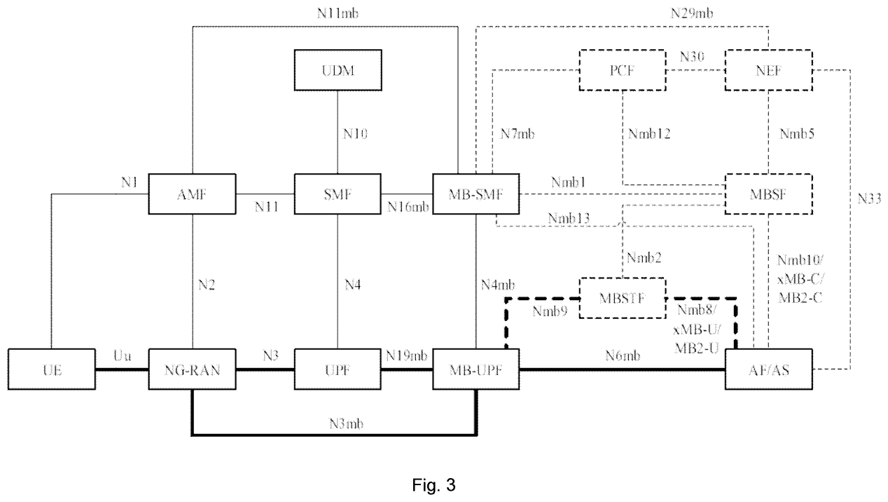

FIG. 6 is a flowchart illustrating a method 600 according to an embodiment of the present disclosure. The method can be performed by e.g., an MB-SMF, e.g., the MB-SMF shown in FIG. 2 or 3. In an example, the method may be applied in the CP solution described above, where restart or failure of an NG-RAN is detected by an AMF.

At block 610, the MB-SMF receives, from an AMF, an ID of an NG-RAN and an indication of restart or failure (NG-RAN failure or path failure) of the NG-RAN. In an example, an ID of a Multicast/Broadcast Service, MBS, session associated with the NG-RAN may be received together with the ID of the NG-RAN and the indication of restart or failure of the NG-RAN. For example, the ID of the NG-RAN, the indication of restart or failure of the NG-RAN, and the ID of the MBS session may be contained in an MBS broadcast context status notify request (e.g., an Namf_MBSBroadcast_ContextStatusNotify Request). The ID of the NG-RAN may be contained in an N2 SM information container (e.g., transparent to the AMF) or be carried outside the N2 SM information container (e.g., added by the AMF).

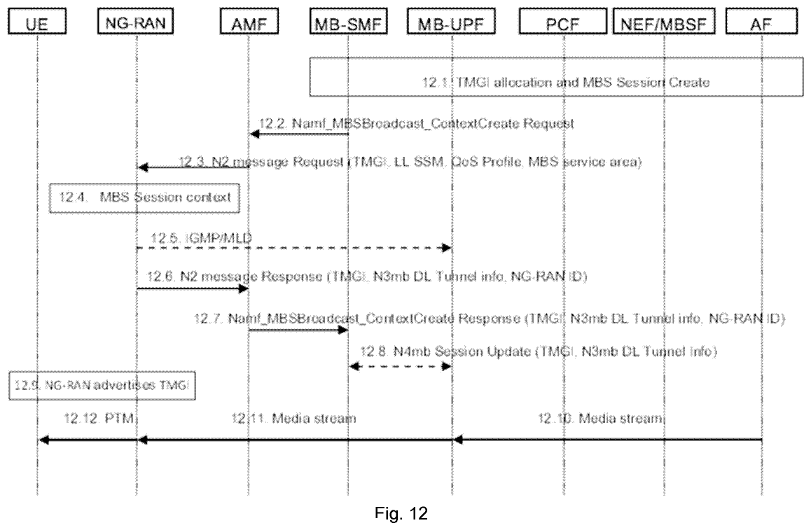

In an example, prior to the block 610, the MB-SMF may receive, from the AMF in a start or update procedure for the MBS session (e.g., MBS session start process illustrated in FIG. 12), a message containing the ID of the NG-RAN (e.g., an Namf_MBSBroadcast_ContextCreate Response). For example, e.g., for unicast transport over N3mb, the message may further contain tunnel information of a DL tunnel for the MBS session, which may be contained in the N2 SM information container. Accordingly, the MB-SMF may maintain a mapping between the ID of the NG-RAN and the tunnel information.

In an example, in response to receiving the indication of restart or failure of the NG-RAN, the MB-SMF may transmit, to an MB-UPF, a session modification request (e.g., an N4mb Session Modification Request), to release the DL tunnel corresponding to the NG-RAN. The session modification request may contain the ID of the MBS session and the tunnel information.

In an example, in response to receiving the indication of restart of the NG-RAN in the block 610, the MB-SMF may transmit, to the AMF, a request to restore the MBS session towards the NG-RAN (e.g., an MBSBroadcast_ContextUpdate Request or an MBSBroadcast_ContextCreate Request). The request may contain the ID of the NG-RAN and the ID of the MBS session. The request may further contain an indication of MBS session restoration.

In an example, after transmitting the request to restore the MBS session, the MB-SMF may receive, from the AMF, a response to the request to restore the MBS session (e.g., an Namf_MBSBroadcast_ContextUpdate Response) or an MBS broadcast context status notify request (e.g., an Namf_MBSBroadcast_ContextStatusNotify Request). For example, the response or the MBS broadcast context status notify request may contain the ID of the NG-RAN. For example, e.g., for unicast transport over N3mb, the response or the MBS broadcast context status notify request may further contain tunnel information of another DL tunnel for the MBS session. Accordingly, the MB-SMF may maintain a mapping between the ID of the NG-RAN and the tunnel information of the other DL tunnel.

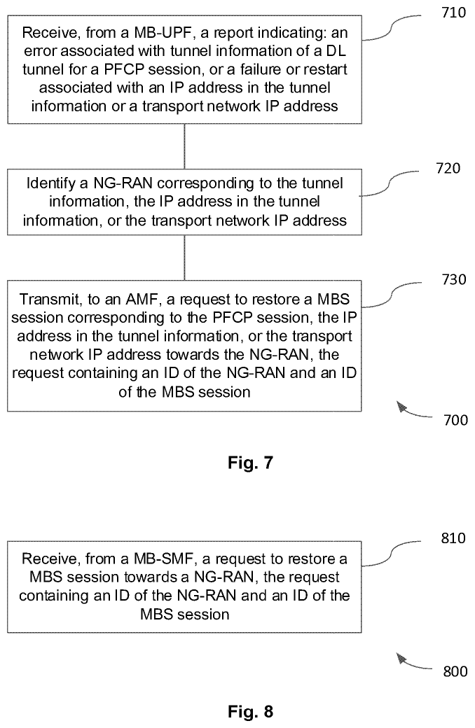

FIG. 7 is a flowchart illustrating a method 700 according to another embodiment of the present disclosure. The method can be performed by e.g., an MB-SMF, e.g., the MB-SMF shown in FIG. 2 or 3. In an example, the method may be applied in the UP solution described above, where restart or failure of an NG-RAN is detected by an MB-UPF.

At block 710, the MB-SMF receives, from an MB-UPF, a report indicating an error associated with tunnel information of a DL tunnel for a PFCP session (e.g., for unicast transport over N3mb), or indicating a failure or restart associated with an IP address in the tunnel information (e.g., for unicast transport over N3mb) or a transport network IP address (e.g., for multicast transport over N3mb). Here, the transport network IP address may be an IP address for user plane path management. In an example, the report indicating the error may be a PFCP session report (e.g., an N4mb Session Report Request), or the report indicating the failure or restart may be a node-level report (e.g., an N4mb Node Report Request).

At block 720, the MB-SMF identifies an NG-RAN corresponding to the tunnel information, the IP address in the tunnel information, or the transport network IP address.

At block 730, the MB-SMF transmits, to an AMF, a request to restore an MBS session corresponding to the PFCP session, the IP address in the tunnel information, or the transport network IP address towards the NG-RAN. For example, the request may contain an ID of the NG-RAN and an ID of the MBS session. In an example, the request may further contain an indication of MBS session restoration. In an embodiment, the request may be an MBSBroadcast_ContextUpdate Request or an MBSBroadcast_ContextCreate Request.

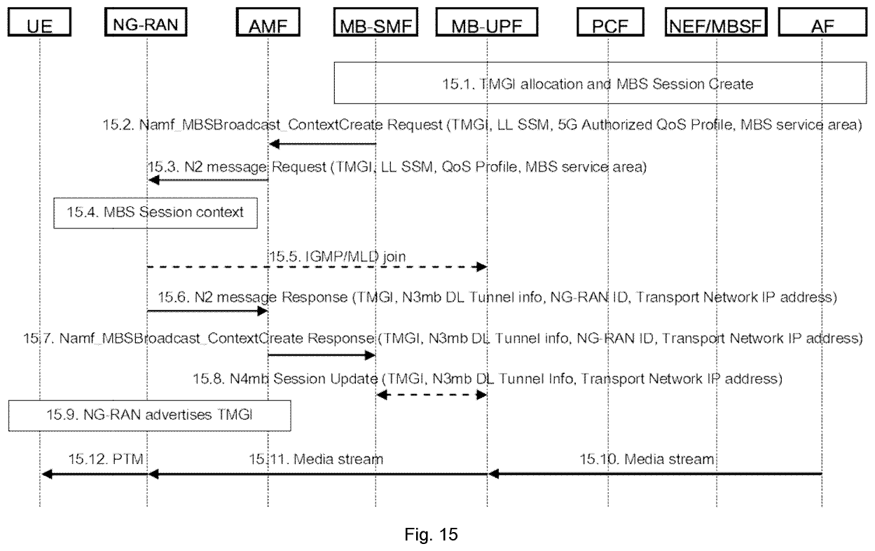

In an example, prior to the block 710, the MB-SMF may receive, from the AMF in a start or update procedure for the MBS session (e.g., MBS session start process illustrated in FIG. 15), a message containing the ID of the NG-RAN (e.g., an Namf_MBSBroadcast_ContextCreate Response). For example, the ID of the NG-RAN may be contained in an N2 SM information container (e.g., transparent to the AMF) or be carried outside the N2 SM information container (e.g., added by the AMF). In an example, the message may further contain the tunnel information or the transport network IP address. Accordingly, the MB-SMF may maintain a mapping between the ID of the NG-RAN and the tunnel information, the IP address in the tunnel information, or the transport network IP address. The MB-SMF may signal, to the MB-UPF, the tunnel information or the transport network IP address, e.g., in an N4mb Session Update message.

In an example, e.g., subsequent to the block 730, the MB-SMF may receive, from the AMF, a response to the request to restore the MBS session (e.g., an Namf_MBSBroadcast_ContextUpdate Response) or an MBS broadcast context status notify request (e.g., an Namf_MBSBroadcast_ContextStatusNotify Request). For example, the response or the MBS broadcast context status notify request may contain the ID of the NG-RAN. The response or the MBS broadcast context status notify request may further contain tunnel information of another DL tunnel or another transport network IP address corresponding to the NG-RAN. Accordingly, the MB-SMF may maintain a mapping between the ID of the NG-RAN and the tunnel information of the other DL tunnel, an IP address in the tunnel information of the other DL tunnel, or the other transport network IP address.

FIG. 8 is a flowchart illustrating a method 800 according to an embodiment of the present disclosure. The method can be performed by e.g., an AMF, e.g., the AMF in FIG. 2 or 3. In an example, the method may be applied in the CP or UP solution described above.

At block 810, the AMF receives, from an MB-SMF, a request to restore an MBS session towards an NG-RAN. For example, the request may contain an ID of the NG-RAN. For example, the request may further contain an ID of the MBS session. In an example, the request may further contain an indication of MBS session restoration. In an example, the request may be an MBSBroadcast_ContextUpdate Request or an MBSBroadcast_ContextCreate Request.

In an example, prior to the block 810, in a start or update procedure for the MBS session (e.g., MBS session start process illustrated in FIG. 12 or 15), the AMF may transmit to the MB-SMF, another message (e.g., an Namf_MBSBroadcast_ContextCreate Response) containing the ID of the NG-RAN. For example, the ID of the NG-RAN may be contained in an N2 SM information container. In an example, e.g., for unicast transport over N3mb, the message may further contain tunnel information of a DL tunnel corresponding to the NG-RAN. In this case, the other message may further contain the tunnel information. The tunnel information may be contained in the N2 SM information container (e.g., transparent to the AMF).

Alternatively, prior to the block 810, in a start or update procedure for the MBS session (e.g., MBS session start process illustrated in FIG. 12 or 15), the AMF may transmit, to the MB-SMF, a message (e.g., an Namf_MBSBroadcast_ContextCreate Response) containing the ID of the NG-RAN. In an embodiment, the ID of the NG-RAN may be carried outside an N2 SM information container (e.g., added by the AMF).

In an example, e.g., for unicast transport over N3mb, prior to transmitting the message containing the ID of the NG-RAN, the AMF may receive, from the NG-RAN, another message (e.g., an N2 message response) containing tunnel information of a DL tunnel corresponding to the NG-RAN. For example, the message may further contain the tunnel information. In an example, the tunnel information may be contained in the N2 SM information container.

In an example, subsequent to the block 810, the AMF may transmit, to the NG-RAN, a request to set up resources for the MBS session (e.g., an MBS Session Resource Setup Request). Subsequent to transmitting the above request, the AMF may receive, from the NG-RAN, a response to the request to set up resources for the MBS session (e.g., an MBS Session Resource Setup Response). Then, the AMF may transmit, to the MB-SMF, a response to the request to restore the MBS session (e.g., an Namf_MBSBroadcast_ContextUpdate Response) or an MBS broadcast context status notify request (e.g., an Namf_MBSBroadcast_ContextStatusNotify Request). The response or the MBS broadcast context status notify request may contain the ID of the NG-RAN.

In an example, e.g., in the CP solution described above, prior to the block 810, the AMF may transmit, to the MB-SMF, the ID of the NG-RAN, an indication of restart of the NG-RAN, and the ID of the MBS session. For example, the ID of the NG-RAN, the indication of restart of the NG-RAN, and the ID of the MBS session may be contained in an MBS broadcast context status notify request (e.g., an Namf_MBSBroadcast_ContextStatusNotify Request). Prior to transmitting the indication of restart of the NG-RAN, the AMF may receive, from the NG-RAN, an NG setup request or NG reset request indicating the restart of the NG-RAN, and then determine the ID of the MBS session associated with the NG-RAN.

In an example, e.g., in the UP solution described above, the message received from the NG-RAN may further contain tunnel information of a DL tunnel or a transport network IP address corresponding to the NG-RAN. Here, the transport network IP address may be an IP address for user plane path management. In an embodiment, the other message transmitted to the MB-SMF may further contain the tunnel information or the transport network IP address. The tunnel information or the transport network IP address may be contained in the N2 SM information container. Alternatively, the AMF may receive, from the NG-RAN, another message containing tunnel information of a DL tunnel or a transport network IP address corresponding to the NG-RAN. The message transmitted to the MB-SMF may further contain the tunnel information or the transport network IP address. The tunnel information or the transport network IP address may be contained in the N2 SM information container.

In an embodiment, e.g., in the UP solution described above, subsequent to the block 810, the AMF may transmit, to the NG-RAN, a request to set up resources for the MBS session (e.g., an MBS Session Resource Setup Request), and then receive, from the NG-RAN, a response to the request to set up resources for the MBS session (e.g., an MBS Session Resource Setup Response). In an example, the response may contain the ID of the NG-RAN and tunnel information of another DL tunnel or another transport network IP address corresponding to the NG-RAN. Then, the AMF may transmit, to the MB-SMF, a response to the request to restore the MBS session (e.g., an Namf_MBSBroadcast_ContextUpdate Response) or an MBS broadcast context status notify request (e.g., an Namf_MBSBroadcast_ContextStatusNotify Request). In an example, the response or the MBS broadcast context status notify request may contain the ID of the NG-RAN and the tunnel information of the other DL tunnel or the other transport network IP address corresponding to the NG-RAN.

FIG. 9 is a flowchart illustrating a method 900 according to another embodiment of the present disclosure. The method can be performed by e.g., an AMF, e.g., the AMF shown in FIG. 2 or 3. In an example, the method may be applied in the CP or UP solution described above.

At block 910, the AMF transmits, to an MB-SMF, an ID of an NG-RAN and an indication of failure (NG-RAN failure or path failure) of the NG-RAN. In an example, an ID of a Multicast/Broadcast Service, MBS, session associated with the NG-RAN may be transmitted together with the ID of the NG-RAN and the indication of failure of the NG-RAN. For example, the ID of the NG-RAN, the indication of failure of the NG-RAN, and the ID of the MBS session may be contained in an MBS broadcast context status notify request (e.g., an Namf_MBSBroadcast_ContextStatusNotify Request).

In an example, prior to the block 910, the AMF may detect the failure of the NG-RAN using an SCTP.

In an example, prior to the block 910, in a start or update procedure for the MBS session (e.g., MBS session start process illustrated in FIG. 12 or 15), the AMF may receive, from the NG-RAN, a message (e.g., an N2 message response) containing the ID of the NG-RAN, and then transmit, to the MB-SMF, another message (e.g., an Namf_MBSBroadcast_ContextCreate Response) containing the ID of the NG-RAN. The ID of the NG-RAN may be contained in an N2 SM information container (e.g., transparent to the AMF). In an example, e.g., for unicast transport over N3mb, the message may further contain tunnel information of a DL tunnel corresponding to the NG-RAN, and the other message may further contain the tunnel information. The tunnel information may be contained in the N2 SM information container.

Alternatively, prior to the block 910, in a start or update procedure for the MBS session (e.g., MBS session start process illustrated in FIG. 12 or 15), the AMF may transmit, to the MB-SMF, a message (e.g., an Namf_MBSBroadcast_ContextCreate response) containing the ID of the NG-RAN. For example, the ID of the NG-RAN may be carried outside an N2 SM information container (e.g., transparent to the AMF). In an example, e.g., for unicast transport over N3mb, prior to transmitting the message, the AMF may receive, from the NG-RAN, another message (e.g., an N2 message response) containing tunnel information of a DL tunnel corresponding to the NG-RAN. Accordingly, the message transmitted to the MB-SMF may further contain the tunnel information. The tunnel information may be contained in the N2 SM information container.

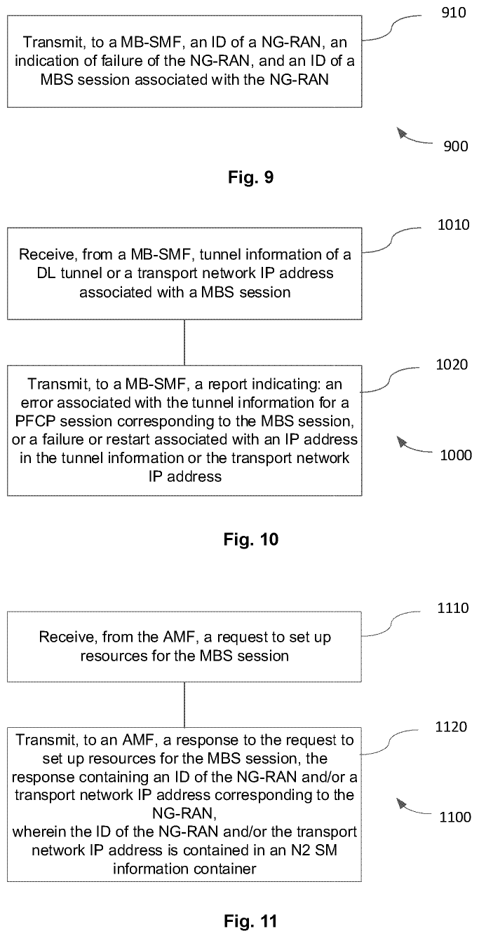

FIG. 10 is a flowchart illustrating a method 1000 according to an embodiment of the present disclosure. The method can be performed by e.g., an MB-UPF, e.g., the MB-UPF shown in FIG. 2 or 3. In an example, the method may be applied in the UP solution described above.

At block 1010, the MB-UPF receives, from an MB-SMF, tunnel information of a DL tunnel (e.g., for unicast transport over N3mb) or a transport network IP address (e.g., for multicast transport over N3mb) associated with an MBS session, e.g., in an N4mb Session Update message in the MBS session start process illustrated in FIG. 15. Here, the transport network IP address may be an IP address for user plane path management.

At block 1020, the MB-UPF transmits, to an MB-SMF, a report indicating an error associated with the tunnel information for a PFCP session corresponding to the MBS session (e.g., for unicast transport over N3mb), or indicating a failure or restart associated with an IP address in the tunnel information or the transport network IP address (e.g., for multicast transport over N3mb). In an example, the report indicating the error may be a PFCP session report (e.g., an N4mb Session Report Request), or the report indicating the failure or restart may be a node-level report (e.g., an N4mb Node Report Request).

In an example, e.g., for unicast transport over N3mb, prior to the block 1020, the MB-SMF may transmit, to an NG-RAN, a packet based on the tunnel information (e.g., towards an IP address in the tunnel information), and then receive, from the NG-RAN, the indication indicating the error.

In an example, the MB-UPF may receive, from the MB-SMF, a session modification request (e.g., an N4mb Session Modification Request) to release the DL tunnel corresponding to the NG-RAN. The session modification request may contain an ID of the MBS session and the tunnel information.

In an example, subsequent to the block 1010 and prior to block 1020, the MB-UPF may transmit a request for user plane path management to the IP address in the tunnel information (e.g., for unicast transport over N3mb) or the transport network IP address (e.g., for multicast transport over N3mb). Then, the MB-SMF may receive, from the IP address in the tunnel information or the transport network IP address, a response containing information from which the restart is derivable (e.g., restart counter), or determine the failure in response to receiving no response to the request from the IP address in the tunnel information or the transport network IP address for a predetermined time period. For example, the request for user plane path management may be a GTP-U echo request and the response may be a GTP-U echo response.

FIG. 11 is a flowchart illustrating a method 1100 according to an embodiment of the present disclosure. The method can be performed by e.g., an NG-RAN (or NG-RAN node, which is used herein interchangeably with NG-RAN), e.g., the NG-RAN in FIG. 2 or 3. In an example, the method may be applied in the CP or UP solution described above.

At block 1110, the NG-RAN receives, from the AMF, a request to set up resources for the MBS session (e.g., an MBS Session Resource Setup Request).

At block 1120, the NG-RAN transmits, to an AMF, a response to the request to set up resources for the MBS session (e.g., an MBS Session Resource Setup Response). The response contains an ID of the NG-RAN and/or a transport network IP address corresponding to the NG-RAN. The ID of the NG-RAN and/or the transport network IP address is contained in an N2 SM information container.

The above methods 600, 700, 800, 900, 1000, and 1100 will be explained in further detail below with reference to FIGS. 12-17.

FIG. 12 is a sequence chart illustrating an exemplary MBS session start process for a broadcast MBS session according to an embodiment of the present disclosure. This process may be applied in the CP solution described above.

At 12.1, to establish a broadcast MBS session, an AF performs Temporary Mobile Group Identity (TMGI) allocation and MBS session creation. The MBS service type indicates to be a broadcast service. At 12.2, an MB-SMF may use Network Repository Function (NRF) to discover the AMF(s) based on the MBS service area and select the appropriate one(s). Then the MB-SMF sends the MBS Session Resource Setup Request (TMGI, Lower Layer Multicast (LL MC) Address and source host address, 5G QoS Profile, MBS service area) messages to the selected AMF(s) in parallel if the service type is broadcast service. At 12.3, an AMF transfers the Namf_MBSBroadcast_ContextCreate Request (TMGI, LL MC and source host address, N2 SM information (5G QoS Profile)) message to all NG-RANs which support MBS in the MBS service area. The AMF may include the MBS service area.

At 12.4, NG-RAN creates a Broadcast MBS Session Context, stores the TMGI, the QoS Profile in the MBS Session Context. The LL MC Address and Source Host Address are optional parameters and only provided by MB-SMF to NG-RAN if N3mb multicast transport is configured to be used in the 5GC. If NG-RAN prefers to use N3mb multicast transport (and if LL MC Address is available in NG-RAN), the NG-RAN joins the multicast group (i.e., LL MC Address), or if NG-RAN prefers to use N3mb point-to-point transport (or if the LL MC Address is not available in NG-RAN) between the NG-RAN and MB-UPF, NG-RAN provides its N3mb DL Tunnel Info. At 12.5, the NG-RAN sends an International Group Management Protocol (IGMP)/Multicast Listener Discover (MLD) join message to the AMF. At 12.6, the NG-RAN reports successful establishment of the MBS Session resources (which may include multiple MBS QoS Flows) by sending MBS Session Resource Setup Response (TMGI, N3mb DL Tunnel Info, NG-RAN ID) message(s) to the AMF. N3mb DL Tunnel Info is contained in an N2 SM information container. N3mb DL Tunnel Info is only available when point-to-point transport applies between MB-UPF and NG-RAN. The NG-RAN ID may be contained in an N2 SM information container. In this case, the NG-RAN ID may be forwarded transparently at Step 12.7. Alternatively, the NG-RAN ID may be carried outside the N2 SM information container.

At 12.7, the AMF transfers the Namf_MBSBroadcast_ContextCreate Response (TMGI, N3mb DL Tunnel Info, NG-RAN ID) to the MB-SMF. The AMF should respond success when it receives the first success response from the NG-RAN(s). And if all NG-RAN(s) report failure, the AMF should respond failure. The MB-SMF stores the AMF(s) which responds success in the MBS Session Context as the downstream nodes. At 12.8, if N3mb point-to-point transport is to be used (i.e., N3mb DL Tunnel Info is present in the MBS Session Start Response message from AMF), the MB-SMF sends an N4mb Session Modification Request to the MB-UPF to allocate the N3mb point-to-point transport tunnel for a replicated MBS stream for the MBS Session. Otherwise, step 12.8 can be skipped. At 12.9, NG-RAN advertises the TMGI representing the MBS service over radio interface. Step 12.9 can take place in parallel with Step 12.6. At 12.10, the AF starts transmitting the DL media stream to MB-UPF using the N6mb Tunnel, or optionally un-tunnelled i.e., as an IP multicast stream using the HL MC address. At 12.11, the MB-UPF transmits the media stream to NG-RAN via N3mb multicast transport or point-to-point transport. At 12.12, the NG-RAN transmits the received DL media stream using DL Point-to-Multipoint (PTM) resources.

For further details of the MBS session start process, reference may be made to clause 7.3.1 of TS 23.247. Similarly, in an MBS session update process, the NG-RAN ID may be added by the AMF in Namf_MBSBroadcast_ContextUpdate response towards the MB-SMF. For further details of the MBS session update process, reference may be made to clause 7.3.1 of TS 23.247.

With the above process, for multicast transport over N3mb, the MB-SMF is aware of the NG-RAN IDs of the NG-RANs that have joined the SSM (Source Specific Multicast address) to receive broadcast MBS session data, and for unicast transport over N3mb, the MB-SMF maintains a mapping between NG-RAN DL Tunnel Info and NG-RAN ID for each NG-RAN for an MBS Session.

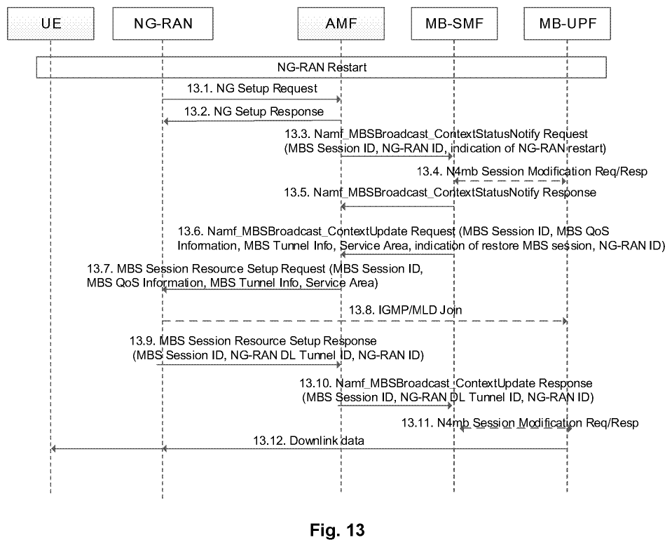

FIG. 13 is a sequence chart illustrating an exemplary process of restoring an MBS session according to an embodiment of the present disclosure. In this example, an MBS session is lost due to restart of an NG-RAN. This process may be applied in the CP solution described above.

In this example, after an NG-RAN restarts, the NG-RAN sends an NG Setup Request or NG Reset Request to an AMF. The AMF then notifies an MB-SMF about the restart of the NG-RAN, so that the MB-SMF may clean relevant broadcast MBS session resources and restore the broadcast MBS session in the NG-RAN.

At 13.1, an NG-RAN sends, to an AMF, an NG Setup Request or NG Reset Request indicating restart or reset of the NG-RAN. At 13.2, the AMF responds an NG Setup Response or NG Reset Response to the NG-RAN. At 13.3, the AMF checks the Broadcast MBS sessions in which the NG-RAN is involved. For each of the Broadcast MBS sessions, the AMF sends, to the relevant MB-SMF, an Namf_MBSBroadcast_ContextStatusNotify Request containing an ID of the MBS session (referred to as MBS Session ID hereinafter), NG-RAN ID and a parameter indicating restart of the NG-RAN (referred to as NG-RAN restart hereinafter). At 13.4, if the parameter indicates NG-RAN restart and unicast transport of N3mb applies to the restarted NG-RAN, the MB-SMF sends, to the MB-UPF, an N4mb Session Modification Request containing MBS Session ID and NG-RAN DL Tunnel ID (and optional NG-RAN ID) to release the N3mb DL tunnel. The MB-UPF releases the N3mb DL tunnel and sends an N4mb Session Modification Response to MB-SMF. For multicast transport of N3mb, Step 13.4 may be optional, as the MB-SMF may only request the MB-UPF to stop multicast transportation when there are no other joined NG-RANs for the MBS session.

At 13.5, the MB-SMF sends an Namf_MBSBroadcast_ContextStatusNotify Response to the AMF. If the parameter indicates NG-RAN restart received in Step 13.3, the MB-SMF needs to restore the MBS session towards the restarted NG-RAN. Then, at 13.6, the MB-SMF sends, to the AMF, an Namf_MBSBroadcast_ContextUpdate Request containing MBS Session ID, MBS QoS Information, MBS Tunnel Info, MBS Service area, an optional indication of MBS session restoration, and an optional NG-RAN ID. At 13.7, based on the indication of MBS session restoration and the NG-RAN ID, the AMF sends, to the NG-RAN, an MBS Session Resource Setup Request/MBS Session Resource Update Request containing MBS Session ID, MBS Tunnel Info, MBS QoS Information and MBS Service area. If the NG-RAN ID is not provided, the AMF is also able to identify the restarted NG-RAN which is within the MBS service area but the broadcast MBS session resource hasn't been setup yet.

At 13.8, the NG-RAN can join the SSM based on MBS Tunnel Info for multicast transport of N3mb. At 13.9, the NG-RAN allocates a new NG-RAN DL Tunnel ID for unicast transport of N3mb. The NG-RAN sends, to the AMF, an MBS Session Resource Setup Response/MBS Session Resource Update Response containing MBS Session ID. If the NG-RAN DL Tunnel ID is allocated, it needs to be included in the response. The NG-RAN may also include the NG-RAN ID in the N2 SM information container to inform the MB-SMF about the NG-RAN ID. At 13.10, the AMF sends, to the MB-SMF, an Namf_MBSBroadcast_ContextUpdate Response containing MBS Session ID, NG-RAN DL Tunnel ID and the N2 SM information container received in Step 13.8. The AMF may also include NG-RAN ID outside the N2 SM information container. If the AMF sends an Namf_MBSBroadcast_ContextUpdate Response already, it may utilize an Namf_MBSBroadcast_ContextStatusNotify Request/Response to pass the information to the MB-SMF.

At 13.11, the MB-SMF sends, to the MB-UPF, an N4mb Session Modification Request containing MBS Session ID and NG-RAN DL Tunnel ID to set up the N3mb DL tunnel. The MB-UPF sets up the N3mb DL tunnel and sends an N4mb Session Modification Response to the MB-SMF. For multicast transport of N3mb, Step 13.11 is optional as well. If the multicast transportation of N3mb has been set up in the MB-UPF already, the MB-SMF may not request the MB-UPF for the multicast transportation again. At 13.12, the MB-UPF sends downlink data to NG-RAN, if unicast applies over N3mb. If multicast applies over N3mb, the NG-RAN receives downlink data after join SSM in Step 13.8.

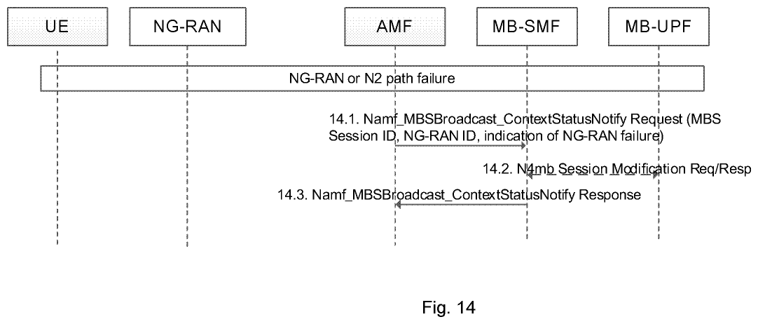

FIG. 14 is a sequence chart illustrating an exemplary process of handling an NG-RAN failure according to an embodiment of the present disclosure. In this example, an MBS session is lost due to failure of an NG-RAN. This process may be applied in the CP solution described above.

In this example, an NG-RAN fails or an N2 path fails. The AMF detects the failure (e.g. in response to no Transport Network Layer (TNL) associations) and notifies the MB-SMF about the NG-RAN failure, so that the MB-SMF may clean relevant broadcast MBS session resources towards the NG-RAN.

At 14.1, when the NG-RAN fails or the N2 path fails, the AMF detects the failure (e.g. in response to no Transport Network Layer (TNL) associations). The AMF checks the Broadcast MBS sessions in which the NG-RAN is involved. For each of the Broadcast MBS sessions, the AMF sends, to the relevant MB-SMF, an Namf_MBSBroadcast_ContextStatusNotify Request containing MBS Session ID, NG-RAN ID and a parameter indicating failure of the NG-RAN (referred to as NG-RAN failure hereinafter). At 14.2, if the parameter indicates NG-RAN failure and unicast transport of N3mb applies to the failed NG-RAN, the MB-SMF sends, to the MB-UPF, N4mb Session Modification Request containing MBS Session ID and NG-RAN DL Tunnel ID (and optional NG-RAN ID) to release the N3mb DL tunnel. The MB-UPF release the N3mb DL tunnel and sends an N4mb Session Modification Response to the MB-SMF. For multicast transport of N3mb, Step 14.2 is optional, as the MB-SMF may only request the MB-UPF to stop multicast transportation when there are no other joined NG-RANs of the MBS session. At 14.3, the MB-SMF sends an Namf_MBSBroadcast_ContextStatusNotify Response to the AMF.

In the CP solution, e.g., described in conjunction with FIG. 13 or 14, the AMF detects NG-RAN restart/failure or N2 path failure, and informs the MB-SMF using a ContextStatusNotify Request in a per MBS session manner. Then, the MB-SMF restores the MBS session towards the restarted NG-RAN via the AMF accordingly.

The CP solution covers both unicast transport and multicast transport over N3mb. It can avoid impact on the NG-RAN, when NG-RAN ID is not included by the NG-RAN. The CP solution works for NG-RAN restart, NG-RAN failure, and path failure between the AMF and the NG-RAN.

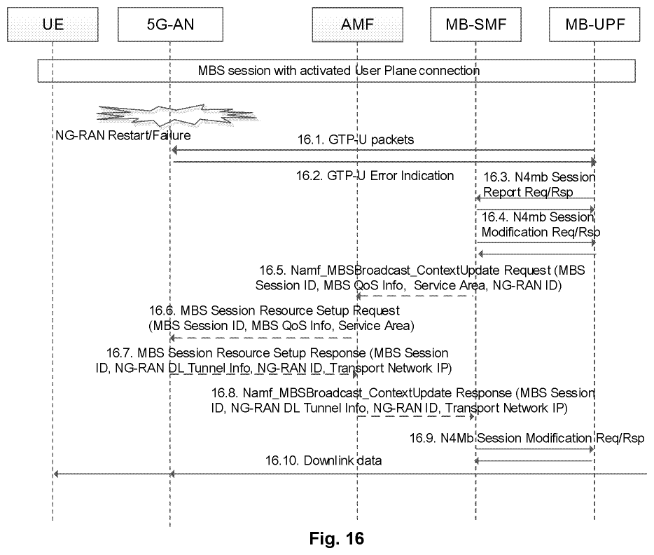

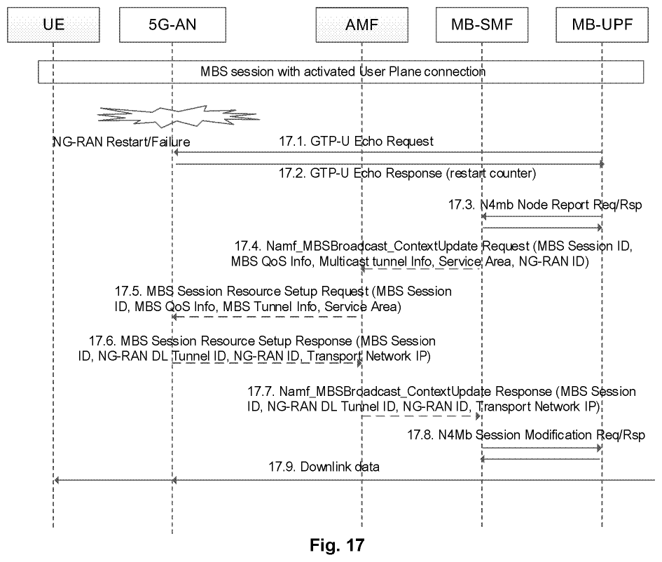

On the other hand, in the UP solution:
For unicast transport over N3mb,
   as already specified in clause 7.3.1 of TS 23.247, NG-RAN provides NG-RAN DL Tunnel Info to MB-UPF so that MB-UPF can send MBS data to the NG-RAN.
   If the GTP-U context is lost in NG-RAN (e.g. due to failure or restart), the MB-UPF will receive GTP-U Error Indication when the MB-UPF sends MBS session data to the NG-RAN based on the N3mb DL Tunnel Info. Upon reception of GTP-U Error Indication, the MB-UPF will report the error indication to the MB-SMF. Further details will be described below referring to FIG. 16.
   MB-UPF may perform path management by sending Echo Request to NG-RAN. If the MB-UPF detects path failure towards the NG-RAN, or restart of NG-RAN, the MB-UPF report the path failure or restart to the MB-UPF. Further details will be described below referring to FIG. 17.
For multicast transport over N3mb:
   Currently NG-RAN simply joins the SSM to receive downlink MBS data, therefore MB-UPF is not aware whether the NG-RAN(s) can successfully receive MBS data.
   To enable path management over N3mb user plane path, the NG-RAN needs to provide a transport network IP address to allow MB-UPF to run “GTP-U echo request” to detect path failure towards the NG-RAN or restart of NG-RAN. When the MB-UPF detects user plane path failure towards the NG-RAN or restart of the NG-RAN, the MB-UPF will report the path failure or NG-RAN restart to the MB-SMF. Further details will be described below referring to FIG. 17.

Upon reception of the report indicating path failure towards the NG-RAN, restart of the NG-RAN, or loss of GTP-U context in the NG-RAN, the MB-SMF triggers MBS Session restoration. Further details will be described below referring to FIGS. 16 and 17.

FIG. 15 is a sequence chart illustrating an exemplary MBS session start process for a broadcast MBS session according to another embodiment of the present disclosure. This process may be applied to the UP solution described above.

Steps 15.1-15.5 and 15.9-15.12 in FIG. 15 are the same as Steps 12.1-12.5 and 12.9-12.12 in FIG. 12, respectively, and details thereof will be omitted here.

At 15.6, in addition to the information described in connection with Step 12.6, the N2 message response may further contain a Transport Network IP address of the NG-RAN, e.g., in the N2 SM information container. This address is required for multicast transport over N3mb for path management and is optional for unicast transport of N3mb. After receiving the Transport Network IP address of the NG-RAN at Step 15.6, the MB-SMF passes it to the MB-UPF at 15.7, then the MB-UPF can perform path management (i.e., send an GTP-U Echo request to the NG-RAN) to detect NG-RAN restart or failure of path between the NG-RAN and the MB-UPF. After Step 15.7, the MB-SMF maintains a mapping between the NG-RAN ID and the Transport Network IP address of the NG-RAN. Correspondingly, at 15.8, in addition to the information described in connection with Step 12.8, the N4mb Session Update message may further contain the received Transport Network IP address of the NG-RAN.

FIG. 16 is a sequence chart illustrating an exemplary process of restoring an MBS session according to an embodiment of the present disclosure. In this example, an MBS session with an activated user plane connection towards an MB-UPF is lost due to restart or failure of an NG-RAN. This process may be applied in the UP solution, where the MB-UPF detects the restart or failure of the NG-RAN. In this example, the restart or failure of the NG-RAN is indicated by a GTP-U Error Indication.

At 16.1, the MB-UPF sends GTP-U packets towards the NG-RAN. At 16.2, the NG-RAN returns a GTP-U Error Indication if it does not have a corresponding GTP-U context. At 16.3, the MB-UPF identifies the related PFCP session and sends an Error Indication Report to the MB-SMF. At 16.4, the MB-SMF modifies the PFCP session to release the downlink tunnel towards the NG-RAN. At 16.5, the MB-SMF initiates an Namf_MBSBroadcast_ContextUpdate Request for the broadcast MBS session. In the request, the MB-SMF provides, to the AMF, MBS Session ID, MBS QoS information, Multicast tunnel info and MBS Service Area, an optional indication of MBS session restoration and an optional parameter NG-RAN ID. At 16.6, the AMF identifies the NG-RAN based on the indication of MBS session restoration and the NG-RAN ID. The AMF then sends, to the NG-RAN, an MBS Session Resource Setup Request containing MBS Session ID, MBS QoS Info, Multicast tunnel info, MBS service area. At 16.7, the NG-RAN can join the SSM based on MBS Tunnel Info for multicast transport of N3mb. The NG-RAN allocates NG-RAN DL Tunnel Info for unicast transport over N3mb. The NG-RAN sends, to the AMF, an MBS Session Resource Setup Response containing MBS Session ID. If the NG-RAN DL Tunnel Info is allocated, it needs to be included in the response. The NG-RAN may also include NG-RAN ID in the N2 SM information container to inform the MB-SMF about the NG-RAN ID. The NG-RAN may include a Transport Network IP address in the N2 SM information container, which is required for multicast transport over N3mb and is optional for unicast transport of N3mb. At 16.8, the AMF sends, to the MB-SMF, an Namf_MBSBroadcast_ContextUpdate Response containing MBS Session ID, the N2 SM information container which may include the NG-RAN ID and/or Transport Network IP address. The AMF may also include the NG-RAN ID outside the N2 SM information container. If the AMF sends an Namf_MBSBroadcast_ContextUpdate Response already, it may utilize an Namf_MBSBroadcast_ContextStatusNotify Request/Response to pass the information to the MB-SMF. At 16.9, the MB-SMF sends, to the MB-UPF, an N4mb Session Modification Request containing MBS Session ID and NG-RAN DL Tunnel ID and/or Transport Network IP address. If new NG-RAN DL Tunnel Info is received, the MB-UPF sets up the N3mb DL tunnel for session data delivery. At 16.10, the MB-UPF sends, to the NG-RAN, downlink data via N3mb of unicast transport.

FIG. 17 is a sequence chart illustrating an exemplary process of restoring an MBS session according to another embodiment of the present disclosure. In this example, an MBS session with an activated user plane connection towards an MB-UPF is lost due to restart or failure of an NG-RAN. This process may be applied to the UP solution, where the MB-UPF detects the restart or failure of the NG-RAN. In this example, the restart or failure of the NG-RAN is indicated in a GTP-U Echo Response.

For NG-RAN restart, the following steps are performed. At 17.1, the MB-UPF sends a GTP-U Echo Request towards the NG-RAN, if it has received Transport Network IP address for path management. At 17.2, the NG-RAN sends, to the MB-UPF, a GTP-U Echo Response with an indication of NG-RAN restart. At 17.3, the MB-UPF reports NG-RAN restart to the MB-SMF using a node-level report together with the Transport Network IP of NG-RAN. Then, for each of the impacted broadcast MBS sessions, the MB-SMF triggers an MBS session restoration process at 17.4-17.9, which are the same as Steps 16.5-16.10, respectively, and details thereof will be omitted here.

For NG-RAN failure, the following steps are performed. At 17.1, the MB-UPF sends a GTP-U Echo Request towards the NG-RAN. At 17.2, if the GTP-U Echo Response is not received from the NG-RAN for one or more times, the MB-UPF may consider the NG-RAN fails or the user plane path towards the NG-RAN fails, and then reports NG-RAN failure (or N3mb path failure) at 17.3. Then, for each of the impacted broadcast MBS sessions, the MB-SMF may trigger an MBS session restoration process at 17.4-17.9, which are the same as Steps 16.5-16.10, respectively, and details thereof will be omitted here.

The UP solution works for NG-RAN restart, NG-RAN failure and path failure between the NG-RAN and the MB-UPF. In the UP solution, the NG-RAN needs to provide the Transport Network IP address for multicast transport over N3mb.

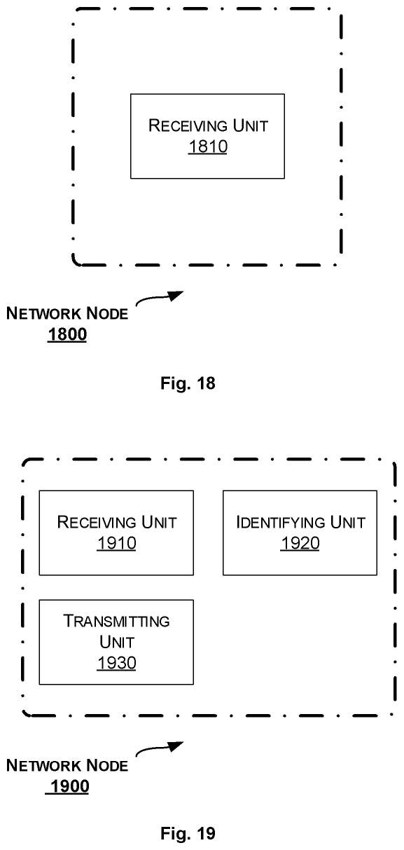

Correspondingly to the method 600 as described above, a network node is provided. FIG. 18 is a block diagram of a network node 1800 according to an embodiment of the present disclosure.

The network node 1800 can be, e.g., the MB-SMF shown in FIG. 2 or 3, and can be configured to perform the method 600 as described above in connection with FIG. 6. As shown in FIG. 18, the network node 1800 includes a receiving unit 1810 configured to receive, from an AMF, an ID of an NG-RAN and an indication of restart or failure of the NG-RAN.

In an embodiment, an ID of a Multicast/Broadcast Service, MBS, session associated with the NG-RAN may be received together with the ID of the NG-RAN and the indication of restart or failure of the NG-RAN.

In an embodiment, the ID of the NG-RAN, the indication of restart or failure of the NG-RAN, and the ID of the MBS session may be contained in an MBS broadcast context status notify request.

In an embodiment, the receiving unit 1810 may be further configured to, prior to the operation of receiving: receive, from the AMF in a start or update procedure for the MBS session, a message containing the ID of the NG-RAN.

In an embodiment, the ID of the NG-RAN may be contained in an N2 SM information container or be carried outside the N2 SM information container.

In an embodiment, the message may further contain tunnel information of a DL tunnel for the MBS session. In an embodiment, the tunnel information may be contained in the N2 SM information container. In an embodiment, the network node 1800 may further include a maintaining unit configured to: maintain a mapping between the ID of the NG-RAN and the tunnel information.

In an embodiment, the network node 1800 may further include a transmitting unit configured to: transmit, to an MB-UPF, in response to receiving the indication, a session modification request to release the DL tunnel corresponding to the NG-RAN. In an embodiment, the session modification request may contain the ID of the MBS session and the tunnel information.

In an embodiment, the transmitting unit may be further configured to: transmit, to the AMF in response to receiving the indication of restart of the NG-RAN, a request to restore the MBS session towards the NG-RAN. In an embodiment, the request may contain the ID of the NG-RAN and the ID of the MBS session.

In an embodiment, the request may be an MBS Broadcast Context Update request or an MBS Broadcast Context Create request.

In an embodiment, the request may further contain an indication of MBS session restoration.

In an embodiment, the receiving unit 1810 may be further configured to: receive, from the AMF, a response to the request to restore the MBS session, or an MBS broadcast context status notify request. In an embodiment, the response or the MBS broadcast context status notify request may contain the ID of the NG-RAN.

In an embodiment, the response or the MBS broadcast context status notify request may further contain tunnel information of another DL tunnel for the MBS session. In an embodiment, the maintaining unit may be further configured to: maintain a mapping between the ID of the NG-RAN and the tunnel information of the other DL tunnel.

The unit 1810 can be implemented as a pure hardware solution or as a combination of software and hardware, e.g., by one or more of: a processor or a micro-processor and adequate software and memory for storing the software, a Programmable Logic Device (PLD) or other electronic component(s) or processing circuitry configured to perform the actions described above, and illustrated, e.g., in FIG. 6.

Correspondingly to the method 700 as described above, a network node is provided. FIG. 19 is a block diagram of a network node 1900 according to another embodiment of the present disclosure.

The network node 1900 can be, e.g., the MB-SMF shown in FIG. 2 or 3, and can be configured to perform the method 700 as described above in connection with FIG. 7. As shown in FIG. 19, the network node 1900 includes a receiving unit 1910 configured to: receive, from an MB-UPF, a report indicating: an error associated with tunnel information of a DL tunnel for a PFCP session, or a failure or restart associated with an IP address in the tunnel information or a transport network IP address. The network node 1900 further includes an identifying unit 1920 configured to: identify an NG-RAN corresponding to the tunnel information, the IP address in the tunnel information, or the transport network IP address. The network node 1900 further includes a transmitting unit 1930 configured to: transmit, to an AMF, a request to restore an MBS session corresponding to the PFCP session, the IP address in the tunnel information, or the transport network IP address towards the NG-RAN. The request contains an ID of the NG-RAN and an ID of the MBS session.

In an embodiment, the report may be a PFCP session report or a node-level report.

In an embodiment, the receiving unit 1910 may be further configured to, prior to the operation of receiving: receive, from the AMF in a start or update procedure for the MBS session, a message containing the ID of the NG-RAN.

In an embodiment, the ID of the NG-RAN may be contained in an N2 SM information container or be carried outside the N2 SM information container.

In an embodiment, the message may further contain the tunnel information or the transport network IP address.

In an embodiment, the network node 1900 may further include a maintaining unit configured to: maintain a mapping between the ID of the NG-RAN and the tunnel information, the IP address in the tunnel information, or the transport network IP address.

In an embodiment, the network node 1900 may further include a signaling unit configured to: signal, to the MB-UPF, the tunnel information or the transport network IP address.

In an embodiment, the receiving unit 1910 may be further configured to: receive, from the AMF, a response to the request to restore the MBS session, or an MBS broadcast context status notify request. In an embodiment, the response or the MBS broadcast context status notify request may contain the ID of the NG-RAN.

In an embodiment, the response or the MBS broadcast context status notify request may further contain tunnel information of another DL tunnel or another transport network IP address corresponding to the NG-RAN.

In an embodiment, the maintaining unit may be further configured to: maintain a mapping between the ID of the NG-RAN and the tunnel information of the other DL tunnel, an IP address in the tunnel information of the other DL tunnel, or the other transport network IP address.

In an embodiment, the transport network IP address may be an IP address for user plane path management.

In an embodiment, the request to restore the MBS session may be an MBS Broadcast Context Update request or an MBS Broadcast Context Create request.

In an embodiment, the request to restore the MBS session may further contain an indication of MBS session restoration.

The units 1910˜1930 can be implemented as a pure hardware solution or as a combination of software and hardware, e.g., by one or more of: a processor or a micro-processor and adequate software and memory for storing the software, a Programmable Logic Device (PLD) or other electronic component(s) or processing circuitry configured to perform the actions described above, and illustrated, e.g., in FIG. 7.

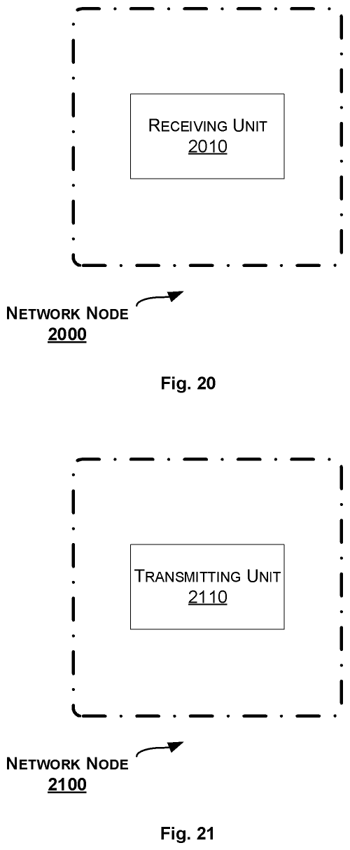

Correspondingly to the method 800 as described above, a network node is provided. FIG. 20 is a block diagram of a network node 2000 according to another embodiment of the present disclosure.

The network node 2000 can be, e.g., the AMF shown in FIG. 2 or 3, and can be configured to perform the method 800 as described above in connection with FIG. 8. As shown in FIG. 20, the network node 2000 includes a receiving unit 2010 configured to: receive, from an MB-SMF, a request to restore an MBS session towards an NG-RAN. The request contains an ID of the NG-RAN. The request may further contain an ID of the MBS session.

In an embodiment, the receiving unit 2010 may be further configured to, prior to the operation of receiving, in a start or update procedure for the MBS session: transmitting, to the MB-SMF, another message containing the ID of the NG-RAN.

In an embodiment, the ID of the NG-RAN may be contained in an N2 SM information container.

In an embodiment, the message may further contain tunnel information of a DL tunnel corresponding to the NG-RAN. In an embodiment, the other message may further contain the tunnel information. In an embodiment, the tunnel information may be contained in the N2 SM information container.

In an embodiment, the network node 2000 may further include a transmitting unit configured to, in a start or update procedure for the MBS session: transmit, to the MB-SMF, a message containing the ID of the NG-RAN. In an embodiment, the ID of the NG-RAN may be carried outside an N2 SM information container.

In an embodiment, the receiving unit 2010 maybe further configured to: receive, from the NG-RAN, another message containing tunnel information of a DL tunnel corresponding to the NG-RAN. In an embodiment, the message may further contain the tunnel information. In an embodiment, the tunnel information may be contained in the N2 SM information container.

In an embodiment, the transmitting unit may be further configured to, subsequent to receiving the request to restore the MBS session: transmit, to the NG-RAN, a request to set up resources for the MBS session. In an embodiment, the receiving unit 2010 may be further configured to: receive, from the NG-RAN, a response to the request to set up resources for the MBS session. In an embodiment, the transmitting unit may be further configured to: transmit, to the MB-SMF, a response to the request to restore the MBS session, or an MBS broadcast context status notify request. In an embodiment, the response or the MBS broadcast context status notify request may contain the ID of the NG-RAN.

In an embodiment, the transmitting unit may be further configured to, prior to receiving the request to restore the MBS session: transmit, to the MB-SMF, the ID of the NG-RAN, an indication of restart of the NG-RAN, and the ID of the MBS session.

In an embodiment, the ID of the NG-RAN, the indication of restart of the NG-RAN, and the ID of the MBS session may be contained in an MBS broadcast context status notify request.

In an embodiment, the receiving unit 2010 may be further configured to, prior to transmitting the indication of restart of the NG-RAN: receive, from the NG-RAN, an NG setup request or NG reset request indicating the restart of the NG-RAN. In an embodiment, the network node 2000 may further include a determining unit configured to determine the ID of the MBS session associated with the NG-RAN.

In an embodiment, the message may further contain tunnel information of a DL tunnel or a transport network IP address corresponding to the NG-RAN. In an embodiment, the other message may further contain the tunnel information or the transport network IP address. In an embodiment, the tunnel information or the transport network IP address may be contained in the N2 SM information container.

In an embodiment, the receiving unit 2010 may be further configured to receive, from the NG-RAN, another message containing tunnel information of a DL tunnel or a transport network IP address corresponding to the NG-RAN. In an embodiment, the message may further contain the tunnel information or the transport network IP address. In an embodiment, the tunnel information or the transport network IP address may be contained in the N2 SM information container.

In an embodiment, the transmitting unit may be further configured to, subsequent to receiving the request to restore the MBS session: transmit, to the NG-RAN, a request to set up resources for the MBS session. In an embodiment, the receiving unit 2010 may be further configured to: receive, from the NG-RAN, a response to the request to set up resources for the MBS session. In an embodiment, the response may contain the ID of the NG-RAN and tunnel information of another DL tunnel or another transport network IP address corresponding to the NG-RAN. In an embodiment, the transmitting unit may be further configured to: transmit, to the MB-SMF, a response to the request to restore the MBS session or an MBS broadcast context status notify request. In an embodiment, the response or the MBS broadcast context status notify request may contain the ID of the NG-RAN and the tunnel information of the other DL tunnel or the other transport network IP address corresponding to the NG-RAN.

In an embodiment, the transport network IP address may be an IP address for user plane path management.

In an embodiment, the request to restore the MBS session may be an MBS Broadcast Context Update request or an MBS Broadcast Context Create request.

In an embodiment, the request to restore the MBS session may further contain an indication of MBS session restoration.

The unit 2010 can be implemented as a pure hardware solution or as a combination of software and hardware, e.g., by one or more of: a processor or a micro-processor and adequate software and memory for storing the software, a Programmable Logic Device (PLD) or other electronic component(s) or processing circuitry configured to perform the actions described above, and illustrated, e.g., in FIG. 8.

Correspondingly to the method 900 as described above, a network node is provided. FIG. 21 is a block diagram of a network node 2100 according to another embodiment of the present disclosure.

The network node 2100 can be, e.g., the AMF shown in FIG. 2 or 3, and can be configured to perform the method 900 as described above in connection with FIG. 9. As shown in FIG. 21, the network node 2100 includes a transmitting unit 2110 configured to: transmit, to an MB-SMF, an ID of an NG-RAN and an indication of failure of the NG-RAN.

In an embodiment, an ID of a Multicast/Broadcast Service, MBS, session associated with the NG-RAN may be transmitted together with the ID of the NG-RAN and the indication of failure of the NG-RAN.

In an embodiment, the ID of the NG-RAN, the indication of failure of the NG-RAN, and the ID of the MBS session may be contained in an MBS broadcast context status notify request.

In an embodiment, the network node 2100 may further include a detecting unit configured to, prior to the operation of transmitting: detect the failure of the NG-RAN using a SCTP.

In an embodiment, the network node 2100 may further include a transmitting unit configured to, in a start or update procedure for the MBS session: receive, from the NG-RAN, a message containing the ID of the NG-RAN. In an embodiment, the transmitting unit 2110 may be further configured to: transmit, to the MB-SMF, another message containing the ID of the NG-RAN. In an embodiment, the ID of the NG-RAN may be contained in an N2 SM information container.

In an embodiment, the message may further contain tunnel information of a DL tunnel corresponding to the NG-RAN. In an embodiment, the other message may further contain the tunnel information. In an embodiment, the tunnel information may be contained in the N2 SM information container.

In an embodiment, the transmitting unit 2110 may be further configured to, in a start or update procedure for the MBS session: transmit, to the MB-SMF, a message containing the ID of the NG-RAN. In an embodiment, the ID of the NG-RAN may be carried outside an N2 SM information container.

In an embodiment, the receiving unit may be further configured to: receive, from the NG-RAN, another message containing tunnel information of a DL tunnel corresponding to the NG-RAN. In an embodiment, the message may further contain the tunnel information. In an embodiment, the tunnel information may be contained in the N2 SM information container.

The unit 2110 can be implemented as a pure hardware solution or as a combination of software and hardware, e.g., by one or more of: a processor or a micro-processor and adequate software and memory for storing the software, a Programmable Logic Device (PLD) or other electronic component(s) or processing circuitry configured to perform the actions described above, and illustrated, e.g., in FIG. 9.

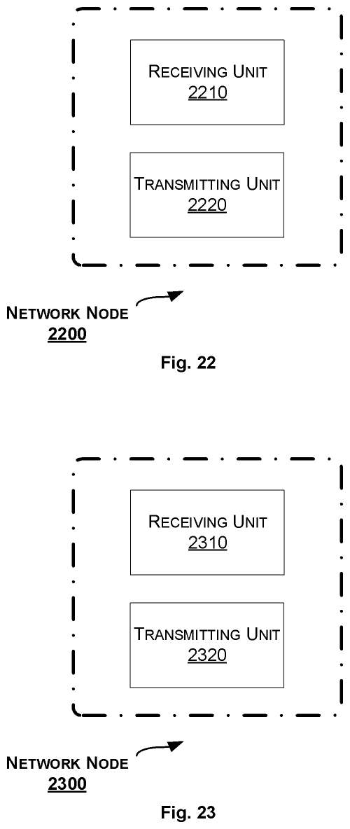

Correspondingly to the method 1000 as described above, a network node is provided. FIG. 22 is a block diagram of a network node 2200 according to another embodiment of the present disclosure.

The network node 2200 can be, e.g., the MB-UPF shown in FIG. 2 or 3, and can be configured to perform the method 1000 as described above in connection with FIG. 10. As shown in FIG. 22, the network node 2200 includes a receiving unit 2210 configured to: receive, from an MB-SMF, tunnel information of a DL tunnel or a transport network IP address associated with an MBS session. The network node 2200 further includes a transmitting unit 2220 configured to: transmit, to an MB-SMF, a report indicating an error associated with the tunnel information for a PFCP session corresponding to the MBS session, or a failure or restart associated with an IP address in the tunnel information or the transport network IP address.

In an embodiment, the report may be a PFCP session report or a node-level report.

In an embodiment, the transmitting unit 2220 may be further configured to, prior to the operation of transmitting: transmit, to an NG-RAN, a packet based on the tunnel information. In an embodiment, the receiving unit 2210 may be further configured to: receive, from the NG-RAN, the indication indicating the error.

In an embodiment, the receiving unit 2210 may be further configured to: receive, from the MB-SMF, a session modification request to release the DL tunnel corresponding to the NG-RAN. In an embodiment, the session modification request may contain an ID of the MBS session and the tunnel information.

In an embodiment, the transmitting unit 2220 may be further configured to, subsequent to the operation of receiving and prior to the operation of transmitting: transmit a request for user plane path management to the IP address in the tunnel information or the transport network IP address. In an embodiment, the receiving unit 2210 may be further configured to: receive, from the IP address in the tunnel information or the transport network IP address, a response containing information from which the restart is derivable. In an embodiment, the network node 2200 may further include a determining unit configured to: determine the failure in response to receiving no response to the request from the IP address in the tunnel information or the transport network IP address for a predetermined time period.

In an embodiment, the request for user plane path management may be a GTP-U echo request. In an embodiment, the response may be a GTP-U echo response.

In an embodiment, the transport network IP address may be an IP address for user plane path management.

The units 2210˜2220 can be implemented as a pure hardware solution or as a combination of software and hardware, e.g., by one or more of: a processor or a micro-processor and adequate software and memory for storing the software, a Programmable Logic Device (PLD) or other electronic component(s) or processing circuitry configured to perform the actions described above, and illustrated, e.g., in FIG. 10.

Correspondingly to the method 1100 as described above, a network node is provided. FIG. 23 is a block diagram of a network node 2300 according to another embodiment of the present disclosure.

The network node 2300 can be, e.g., the NG-RAN (node) shown in FIG. 2 or 3, and can be configured to perform the method 1100 as described above in connection with FIG. 11. As shown in FIG. 23, the network node 2300 includes a receiving unit 2310 configured to: receive, from the AMF, a request to set up resources for the MBS session. The network node 2300 further includes a transmitting unit 2320 configured to: transmit, to an AMF, a response to the request to set up resources for the MBS session. The response contains an ID of the NG-RAN and/or a transport network IP address corresponding to the NG-RAN. In an embodiment, the ID of the NG-RAN and/or the transport network IP address is contained in an N2 SM information container.

The units 2310˜2320 can be implemented as a pure hardware solution or as a combination of software and hardware, e.g., by one or more of: a processor or a micro-processor and adequate software and memory for storing the software, a Programmable Logic Device (PLD) or other electronic component(s) or processing circuitry configured to perform the actions described above, and illustrated, e.g., in FIG. 11.

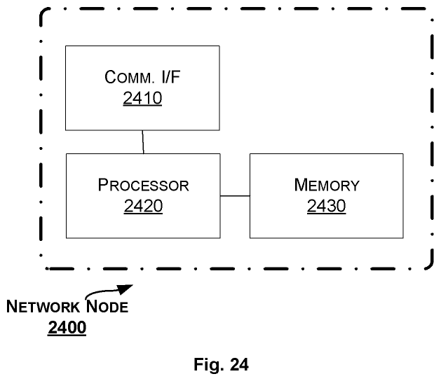

FIG. 24 is a block diagram of a network node 2400 according to another embodiment of the present disclosure.

The network node 2400 includes a communication interface 2410, a processor 2420 and a memory 2430.

As an example, the network node 2400 can be the MB-SMF shown in FIG. 2 or 3. The memory 2430 can contain instructions executable by the processor 2420 whereby the network node 2400 is operative to, when implementing an MB-SMF, perform the actions, e.g., of the process described earlier in conjunction with FIG. 6. Particularly, the memory 2430 can contain instructions executable by the processor 2420 whereby the network node 2400 is operative to, when implementing an MB-SMF: receive, from an AMF, an ID of an NG-RAN and an indication of restart or failure of the NG-RAN.

In an embodiment, an ID of a Multicast/Broadcast Service, MBS, session associated with the NG-RAN may be received together with the ID of the NG-RAN and the indication of restart or failure of the NG-RAN.

In an embodiment, the ID of the NG-RAN, the indication of restart or failure of the NG-RAN, and the ID of the MBS session may be contained in an MBS broadcast context status notify request.

In an example, the memory 2430 can further contain instructions executable by the processor 2420 whereby the network node 2400 is operative to, when implementing the MB-SMF, prior to the operation of receiving: receive, from the AMF in a start or update procedure for the MBS session, a message containing the ID of the NG-RAN.

In an embodiment, the ID of the NG-RAN may be contained in an N2 Session Management (SM) information container or is carried outside the N2 SM information container.

In an embodiment, the message may further contain tunnel information of a DL tunnel for the MBS session. In an embodiment, the tunnel information may be contained in the N2 SM information container. In an example, the memory 2430 can further contain instructions executable by the processor 2420 whereby the network node 2400 is operative to, when implementing the MB-SMF: maintain a mapping between the ID of the NG-RAN and the tunnel information.

In an example, the memory 2430 can further contain instructions executable by the processor 2420 whereby the network node 2400 is operative to, when implementing the MB-SMF: transmit, to an MB-UPF, in response to receiving the indication, a session modification request to release the DL tunnel corresponding to the NG-RAN. In an embodiment, the session modification request may contain the ID of the MBS session and the tunnel information.

In an example, the memory 2430 can further contain instructions executable by the processor 2420 whereby the network node 2400 is operative to, when implementing the MB-SMF: transmit, to the AMF in response to receiving the indication of restart of the NG-RAN, a request to restore the MBS session towards the NG-RAN. In an embodiment, the request may contain the ID of the NG-RAN and the ID of the MBS session.

In an embodiment, the request may be an MBS Broadcast Context Update request or an MBS Broadcast Context Create request.

In an embodiment, the request may further contain an indication of MBS session restoration.

In an example, the memory 2430 can further contain instructions executable by the processor 2420 whereby the network node 2400 is operative to, when implementing the MB-SMF: receive, from the AMF, a response to the request to restore the MBS session or an MBS broadcast context status notify request. In an embodiment, the response or the MBS broadcast context status notify request may contain the ID of the NG-RAN.

In an embodiment, the response or the MBS broadcast context status notify request may further contain tunnel information of another DL tunnel for the MBS session. In an example, the memory 2430 can further contain instructions executable by the processor 2420 whereby the network node 2400 is operative to, when implementing the MB-SMF: maintain a mapping between the ID of the NG-RAN and the tunnel information of the other DL tunnel.

Alternatively, the network node 2400 can be the MB-SMF shown in FIG. 2 or 3. The memory 2430 can contain instructions executable by the processor 2420 whereby the network node 2400 is operative to, when implementing an MB-SMF, perform the actions, e.g., of the process described earlier in conjunction with FIG. 7. Particularly, the memory 2430 can contain instructions executable by the processor 2420 whereby the network node 2400 is operative to, when implementing an MB-SMF: receive, from an MB-UPF, a report indicating: an error associated with tunnel information of a DL tunnel for a PFCP session, or a failure or restart associated with an IP address in the tunnel information or a transport network IP address. In an example, the memory 2430 further contains instructions executable by the processor 2420 whereby the network node 2400 is operative to, when implementing the MB-SMF: identify an NG-RAN corresponding to the tunnel information, the IP address in the tunnel information, or the transport network IP address. In an example, the memory 2430 further contains instructions executable by the processor 2420 whereby the network node 2400 is operative to, when implementing the MB-SMF: transmit, to an AMF, a request to restore an MBS session corresponding to the PFCP session, the IP address in the tunnel information, or the transport network IP address towards the NG-RAN. The request contains an ID of the NG-RAN and an ID of the MBS session.

In an embodiment, the report may be a PFCP session report or a node-level report.

In an example, the memory 2430 can further contains instructions executable by the processor 2420 whereby the network node 2400 is operative to, when implementing the MB-SMF, prior to the operation of receiving: receive, from the AMF in a start or update procedure for the MBS session, a message containing the ID of the NG-RAN.

In an embodiment, the ID of the NG-RAN may be contained in an N2 SM information container or be carried outside the N2 SM information container.

In an embodiment, the message may further contain the tunnel information or the transport network IP address.

In an example, the memory 2430 can further contains instructions executable by the processor 2420 whereby the network node 2400 is operative to, when implementing the MB-SMF: maintain a mapping between the ID of the NG-RAN and the tunnel information, the IP address in the tunnel information, or the transport network IP address.

In an example, the memory 2430 can further contains instructions executable by the processor 2420 whereby the network node 2400 is operative to, when implementing the MB-SMF: signal, to the MB-UPF, the tunnel information or the transport network IP address.

In an example, the memory 2430 can further contains instructions executable by the processor 2420 whereby the network node 2400 is operative to, when implementing the MB-SMF: receive, from the AMF, a response to the request to restore the MBS session, or an MBS broadcast context status notify request, the response or the MBS broadcast context status notify request containing the ID of the NG-RAN.

In an embodiment, the response or the MBS broadcast context status notify request may further contain tunnel information of another DL tunnel or another transport network IP address corresponding to the NG-RAN.

In an example, the memory 2430 can further contains instructions executable by the processor 2420 whereby the network node 2400 is operative to, when implementing the MB-SMF: maintain a mapping between the ID of the NG-RAN and the tunnel information of the other DL tunnel, an IP address in the tunnel information of the other DL tunnel, or the other transport network IP address.

In an embodiment, the transport network IP address may be an IP address for user plane path management.

In an embodiment, the request to restore the MBS session may be an MBS Broadcast Context Update request or an MBS Broadcast Context Create request.

In an embodiment, the request to restore the MBS session may further contain an indication of MBS session restoration.

Alternatively, the network node 2400 can be the AMF shown in FIG. 2 or 3. The memory 2430 can contain instructions executable by the processor 2420 whereby the network node 2400 is operative to, when implementing an AMF, perform the actions, e.g., of the process described earlier in conjunction with FIG. 8. Particularly, the memory 2430 can contain instructions executable by the processor 2420 whereby the network node 2400 is operative to, when implementing an AMF: receive, from an MB-SMF, a request to restore an MBS session towards an NG-RAN. The request contains an ID of the NG-RAN. The request may further contain an ID of the MBS session.

In an example, the memory 2430 further contains instructions executable by the processor 2420 whereby the network node 2400 is operative to, when implementing the AMF, prior to the operation of receiving, in a start or update procedure for the MBS session: transmit, to the MB-SMF, another message containing the ID of the NG-RAN. In an embodiment, the ID of the NG-RAN may be contained in an N2 SM information container.

In an embodiment, the message may further contain tunnel information of a DL tunnel corresponding to the NG-RAN. In an embodiment, the other message may further contain the tunnel information. In an embodiment, the tunnel information may be contained in the N2 SM information container.

In an example, the memory 2430 further contains instructions executable by the processor 2420 whereby the network node 2400 is operative to, when implementing the AMF, prior to the operation of receiving, in a start or update procedure for the MBS session: transmit, to the MB-SMF, a message containing the ID of the NG-RAN. In an embodiment, the ID of the NG-RAN may be carried outside an N2 SM information container.

In an example, the memory 2430 further contains instructions executable by the processor 2420 whereby the network node 2400 is operative to, when implementing the AMF: receive, from the NG-RAN, another message containing tunnel information of a DL tunnel corresponding to the NG-RAN. In an embodiment, the message may further contain the tunnel information. In an embodiment, the tunnel information may be contained in the N2 SM information container.

In an example, the memory 2430 further contains instructions executable by the processor 2420 whereby the network node 2400 is operative to, when implementing the AMF, subsequent to receiving the request to restore the MBS session: transmit, to the NG-RAN, a request to set up resources for the MBS session. In an example, the memory 2430 further contains instructions executable by the processor 2420 whereby the network node 2400 is operative to, when implementing the AMF: receive, from the NG-RAN, a response to the request to set up resources for the MBS session. In an example, the memory 2430 further contains instructions executable by the processor 2420 whereby the network node 2400 is operative to, when implementing the AMF: transmit, to the MB-SMF, a response to the request to restore the MBS session, or an MBS broadcast context status notify request. In an embodiment, the response or the MBS broadcast context status notify request may contain the ID of the NG-RAN.

In an example, the memory 2430 further contains instructions executable by the processor 2420 whereby the network node 2400 is operative to, when implementing the AMF, prior to receiving the request to restore the MBS session: transmit, to the MB-SMF, the ID of the NG-RAN, an indication of restart of the NG-RAN, and the ID of the MBS session.

In an embodiment, the ID of the NG-RAN, the indication of restart of the NG-RAN, and the ID of the MBS session may be contained in an MBS broadcast context status notify request.

In an example, the memory 2430 further contains instructions executable by the processor 2420 whereby the network node 2400 is operative to, when implementing the AMF, prior to transmitting the indication of restart of the NG-RAN: receive, from the NG-RAN, an NG setup request or NG reset request indicating the restart of the NG-RAN. In an example, the memory 2430 further contains instructions executable by the processor 2420 whereby the network node 2400 is operative to, when implementing the AMF: determine the ID of the MBS session associated with the NG-RAN.

In an embodiment, the message may further contain tunnel information of a DL tunnel or a transport network IP address corresponding to the NG-RAN. In an embodiment, the other message may further contain the tunnel information or the transport network IP address. In an embodiment, the tunnel information or the transport network IP address may be contained in the N2 SM information container.

In an example, the memory 2430 further contains instructions executable by the processor 2420 whereby the network node 2400 is operative to, when implementing the AMF: receive, from the NG-RAN, another message containing tunnel information of a DL tunnel or a transport network IP address corresponding to the NG-RAN. In an embodiment, the message may further contain the tunnel information or the transport network IP address. In an embodiment, the tunnel information or the transport network IP address may be contained in the N2 SM information container.

In an example, the memory 2430 further contains instructions executable by the processor 2420 whereby the network node 2400 is operative to, when implementing the AMF, subsequent to receiving the request to restore the MBS session: transmit, to the NG-RAN, a request to set up resources for the MBS session. In an example, the memory 2430 further contains instructions executable by the processor 2420 whereby the network node 2400 is operative to, when implementing the AMF: receive, from the NG-RAN, a response to the request to set up resources for the MBS session, the response containing the ID of the NG-RAN and tunnel information of another DL tunnel or another transport network IP address corresponding to the NG-RAN. In an example, the memory 2430 further contains instructions executable by the processor 2420 whereby the network node 2400 is operative to, when implementing the AMF: transmit, to the MB-SMF, a response to the request to restore the MBS session, or an MBS broadcast context status notify request. In an example, the response or the MBS broadcast context status notify request may contain the ID of the NG-RAN and the tunnel information of the other DL tunnel or the other transport network IP address corresponding to the NG-RAN.

In an embodiment, the transport network IP address may be an IP address for user plane path management.

In an embodiment, the request to restore the MBS session may be an MBS Broadcast Context Update request or an MBS Broadcast Context Create request.

In an embodiment, the request to restore the MBS session may further contain an indication of MBS session restoration.

Alternatively, the network node 2400 can be the AMF shown in FIG. 2 or 3. The memory 2430 can contain instructions executable by the processor 2420 whereby the network node 2400 is operative to, when implementing an AMF, perform the actions, e.g., of the process described earlier in conjunction with FIG. 9. Particularly, the memory 2430 can contain instructions executable by the processor 2420 whereby the network node 2400 is operative to, when implementing an AMF: transmit, to an MB-SMF, an ID of an NG-RAN and an indication of failure of the NG-RAN.

In an embodiment, an ID of a Multicast/Broadcast Service, MBS, session associated with the NG-RAN may be transmitted together with the ID of the NG-RAN and the indication of failure of the NG-RAN.

In an embodiment, the ID of the NG-RAN, the indication of failure of the NG-RAN, and the ID of the MBS session may be contained in an MBS broadcast context status notify request.

In an example, the memory 2430 further contains instructions executable by the processor 2420 whereby the network node 2400 is operative to, when implementing the AMF, prior to the operation of transmitting: detect the failure of the NG-RAN using a SCTP.

In an example, the memory 2430 further contains instructions executable by the processor 2420 whereby the network node 2400 is operative to, when implementing the AMF, prior to the operation of transmitting, in a start or update procedure for the MBS session: receive, from the NG-RAN, a message containing the ID of the NG-RAN. In an example, the memory 2430 further contains instructions executable by the processor 2420 whereby the network node 2400 is operative to, when implementing the AMF: transmit, to the MB-SMF, another message containing the ID of the NG-RAN. In an embodiment, the ID of the NG-RAN may be contained in an N2 SM information container.

In an embodiment, the message may further contain tunnel information of a DL tunnel corresponding to the NG-RAN. In an embodiment, the other message may further contain the tunnel information. In an embodiment, the tunnel information may be contained in the N2 SM information container.

In an example, the memory 2430 further contains instructions executable by the processor 2420 whereby the network node 2400 is operative to, when implementing the AMF, prior to the operation of transmitting, in a start or update procedure for the MBS session: transmit, to the MB-SMF, a message containing the ID of the NG-RAN. In an embodiment, the ID of the NG-RAN may be carried outside an N2 SM information container.

In an example, the memory 2430 further contains instructions executable by the processor 2420 whereby the network node 2400 is operative to, when implementing the AMF: receive, from the NG-RAN, another message containing tunnel information of a DL tunnel corresponding to the NG-RAN. In an embodiment, the message may further contain the tunnel information. In an embodiment, the tunnel information may be contained in the N2 SM information container.

Alternatively, the network node 2400 can be the MB-UPF shown in FIG. 2 or 3. The memory 2430 can contain instructions executable by the processor 2420 whereby the network node 2400 is operative to, when implementing an MB-UPF, perform the actions, e.g., of the process described earlier in conjunction with FIG. 10. Particularly, the memory 2430 can contain instructions executable by the processor 2420 whereby the network node 2400 is operative to, when implementing an MB-UPF: receive, from an MB-SMF, tunnel information of a DL tunnel or a transport network IP address associated with an MBS session. In an example, the memory 2430 further contains instructions executable by the processor 2420 whereby the network node 2400 is operative to, when implementing the MB-UPF: transmit, to an MB-SMF, a report indicating an error associated with the tunnel information for a PFCP session corresponding to the MBS session, or a failure or restart associated with an IP address in the tunnel information or the transport network IP address.

In an embodiment, the report may be a PFCP session report or a node-level report.

In an example, the memory 2430 further contains instructions executable by the processor 2420 whereby the network node 2400 is operative to, when implementing the MB-UPF, prior to the operation of transmitting: transmit, to an NG-RAN, a packet based on the tunnel information; and receiving, from the NG-RAN, the indication indicating the error.

In an example, the memory 2430 further contains instructions executable by the processor 2420 whereby the network node 2400 is operative to, when implementing the MB-UPF: receive, from the MB-SMF, a session modification request to release the DL tunnel corresponding to the NG-RAN. In an embodiment, thee session modification request may contain an ID of the MBS session and the tunnel information.

In an example, the memory 2430 further contains instructions executable by the processor 2420 whereby the network node 2400 is operative to, when implementing the MB-UPF, subsequent to the operation of receiving and prior to the operation of transmitting: transmit a request for user plane path management to the IP address in the tunnel information or the transport network IP address. In an example, the memory 2430 further contains instructions executable by the processor 2420 whereby the network node 2400 is operative to, when implementing the MB-UPF: receive, from the IP address in the tunnel information or the transport network IP address, a response containing information from which the restart is derivable, or determine the failure in response to receiving no response to the request from the IP address in the tunnel information or the transport network IP address for a predetermined time period.

In an embodiment, the request for user plane path management may be a GTP-U echo request. In an embodiment, the response may be a GTP-U echo response.

In an embodiment, the transport network IP address may be an IP address for user plane path management.

Alternatively, the network node 2400 can be the NG-RAN shown in FIG. 2 or 3. The memory 2430 can contain instructions executable by the processor 2420 whereby the network node 2400 is operative to, when implementing an NG-RAN, perform the actions, e.g., of the process described earlier in conjunction with FIG. 11. Particularly, the memory 2430 can contain instructions executable by the processor 2420 whereby the network node 2400 is operative to, when implementing an NG-RAN: receive, from the AMF, a request to set up resources for the MBS session; and transmit, to an AMF, a response to the request to set up resources for the MBS session. The response contains an ID of the NG-RAN and/or a transport network IP address corresponding to the NG-RAN. In an embodiment, the ID of the NG-RAN and/or the transport network IP address is contained in an N2 SM information container.

The present disclosure also provides at least one computer program product in the form of a non-volatile or volatile memory, e.g., a non-transitory computer readable storage medium, an Electrically Erasable Programmable Read-Only Memory (EEPROM), a flash memory and a hard drive. The computer program product includes a computer program. The computer program includes: code/computer readable instructions, which when executed by the processor 2420, causes the network node 2400 to, when implementing an MB-SMF, perform the actions, e.g., of the process described earlier in conjunction with FIG. 6 or 7, or when implementing an AMF, perform the actions, e.g., of the process described earlier in conjunction with FIG. 8 or 9, or when implementing an MB-UPF, perform the actions, e.g., of the process described earlier in conjunction with FIG. 10, or when implementing an NG-RAN, perform the actions, e.g., of the process described earlier in conjunction with FIG. 11.

The computer program product may be configured as a computer program code structured in computer program modules. The computer program modules could essentially perform the actions of the flow illustrated in FIG. 6, 7, 8, 9, 10, or 11.

The processor may be a single CPU (Central Processing Unit), but could also comprise two or more processing units. For example, the processor may include general purpose microprocessors; instruction set processors and/or related chips sets and/or special purpose microprocessors such as Application Specific Integrated Circuits (ASICs). The processor may also comprise board memory for caching purposes. The computer program may be carried by a computer program product connected to the processor. The computer program product may comprise a non-transitory computer readable storage medium on which the computer program is stored. For example, the computer program product may be a flash memory, a Random-Access Memory (RAM), a Read-Only Memory (ROM), or an EEPROM, and the computer program modules described above could in alternative embodiments be distributed on different computer program products in the form of memories.

The disclosure has been described above with reference to embodiments thereof. It should be understood that various modifications, alternations and additions can be made by those skilled in the art without departing from the spirits and scope of the disclosure. Therefore, the scope of the disclosure is not limited to the above particular embodiments but only defined by the claims as attached.

The present disclosure further provides the following embodiments.

For 5GC, the Network Functions in the control plane are required to support NF (Service) Set to enable the resource/session contexts are shared by multiple NF service instances in the same NF (service) set to achieve redundancy thus provide high reliability to the 5G services. So, there is no need to further specify restoration procedure upon a NF in control plane failure.

There is no Set concept introduced for UPF and MB-UPF, while since UPF and MB-UPF are fully controlled by the SMF and MB-SMF respectively, hence when there is a failure in a UPF or an MB-UPF, the SMF or MB-SMF can always restore the sessions.

However, there is lack of mechanisms to restore an MBS session when there is an NG-RAN restart. For an NG-RAN failure without restart, the MBS session for the area which is served by the failed NG-RAN is not possible to be restored, though relevant resource in the Core Network can be released, e.g., the MB-UPF should not send a separate copy of MBS session data to the NG-RAN which has failed.

Conclusion 1: Existing mechanisms in 5GC cannot restore an MBS session when there is a failure/restart of a 5GC NF concerning an MBS session. 3GPP needs to specify restoration procedure to restore MBS session(s) affected by an NG-RAN restart.

Clauses 7.3.1 and 7.3.3 in 3GPP TS 23.247 specify how an MBS Session for Broadcast is started and updated. Since the MBS Session Update for broadcast can be used to update the broadcast area, e.g. add a new Tracking Area served by a new NG-RAN, this would be very similar to restore an MBS session in a restarted NG-RAN as if the restarted NG-RAN is new NG-RAN serving a new Tracking Area.

Conclusion 2: The MB-SMF may use MBS Session Update for Broadcast procedure (as specified in clause 7.3.3 of 3GPP TS 23.247) to restore an MBS session in an NG-RAN (recovered from a restart).

NG-RAN Failure with and without Restart
Detection of NG-RAN Failure with and without Restart

When an NG-RAN has restarted, it is assumed that the NG-RAN will lose all its session contexts including those session contexts for the MBS sessions. There is no Set concept introduced for RAN.

### Detection Via Control Plane Path (Via N2 by the AMF):

After being recovered from a restart or a (partial) failure, the NG-RAN shall notify the (partial) failure or restart to the AMF using NG SETUP Request or NG RESET as specified in 3GPP TS 38.413 as cited below.

As specified in clause 8.2. RFC 4960 for SCTP, which is the transport layer protocol for the NGAP over N2 interface, the AMF is also possible to detect an NG-RAN failure with restart.

Conclusion 3: Detection of NG-RAN failure with or without restart can be done by the AMF WITHOUT any protocol impact per existing specification. Such failure can be reported to the MB-SMF via Namf_MBSBroadcast ContextStatusNotify service operation.

### Detection Via User Plane Path (Via N3mb by the MB-UPF):

The peer GTP-U entity (of the NG-RAN) MB-UPF is also possible to detect an NG-RAN failure with and without restart as below:

When unicast transport over N3mb is used: (i.e., the NG-RAN has allocated a DL F-TEID to receive MBS Session data)

The restarted NG-RAN will not recognize the DL F-TEID allocated by the NG-RAN before its restart, hence the NG-RAN will send GTP-U Error Indication. The GTP-U Error Indication will be further reported to the MB-SMF.

The MB-UPF will send periodically Echo Request message to detect liveness of a GTP-U path identified by the IP Address within the DL F-TEID. So, the MB-UPF will be able to detect GTP-U Path failure towards the NG-RAN and if the failure is detected, the MB-UPF will also reported to the MB-SMF.

Conclusion 4a: The MB-UPF will be able to detect NG-RAN failure with or without restart when unicast transport is used per existing specification. The MB-SMF will get failure report from the MB-UPF.

When multicast transport over N3mb is used, where the NG-RAN will JOIN the multicast group, i.e., MBS session data will be retrieved from the lower layer Source Specific Multicast address allocated by the MB-UPF. The MB-UPF will be UNAWARE if there is any NG-RAN restart or failure.

Conclusion 4b: When multicast transport is used for N3mb interface, additional mechanism needs to be introduced, e.g. NG-RAN needs provide an IP Address even when it decides to JOIN the multicast group to enable MB-UPF to send Echo Request towards to detect the restart. RAN3 impact is expected.

Conclusion 4c: With user plane solution, the MB-SMF need store the mapping information between NG-RAN ID and NG-RAN provided transport information, either DL F-TEID to receive MBS session data (for unicast transport) or a separate IP Address (for multicast transport), so that, upon the report from MB-UPF for the failure, which will only include failed Tunnel Endpoint information (for GTP-U Error Indication Report) or Remote GTP-U IP address (for GTP-U path failure), the MB-SMF will be able to derive NG-RAN ID, so to request the restarted NG-RAN to restore the MBS session, via the AMF.

To restore an MBS session for Broadcast, based on the Conclusions 2, 3 and 4a-c, it is proposed:
the AMF shall detect NG-RAN failure with or without restart, and report such failure per MBS session to the MB-SMF via Namf_MBSBroadcast_ContextNotify request with NG-RAN ID and an indication if the NG-RAN is restarted or has failed without restart;
the MB-SMF shall trigger MBS Session update for Broadcast session per MBS session as specified in clause 7.3.3 of TS 23.247 by sending Namf_MBSBroadcast_ContextUpdate request message include the restarted NG-RAN ID.
Upon receiving GTP-U error indication report or GTP-U Path failure report (for unicast transport), the MB-SMF can request MB-UPF to modify the corresponding PFCP session (for the MBS session) to remove the old DL F-TEID).

NOTE: there is no extra user plane resource allocated for a specific NG-RAN when multicast transport is used over N3mb.

1. A method in a Multicast/Broadcast Session Management Function (MB-SMF) comprising:
receiving, from an Access and Mobility Management Function (AMF), an identifier (ID) of a Next Generation-Radio Access Network (NG-RAN) and an indication of restart or failure of the NG-RAN.

2. The method of claim 1, wherein an ID of a Multicast/Broadcast Service (MBS) session associated with the NG-RAN is received together with the ID of the NG-RAN and the indication of restart or failure of the NG-RAN.

3. The method of claim 2, wherein the ID of the NG-RAN, the indication of restart or failure of the NG-RAN, and the ID of the MBS session are contained in an MBS broadcast context status notify request.

4. The method of claim 2, further comprising, prior to said receiving:
receiving, from the AMF in a start or update procedure for the MBS session, a message containing the ID of the NG-RAN; or
receiving, from the AMF in a start or update procedure for the MBS session, a message containing the ID of the NG-RAN, wherein the ID of the NG-RAN is contained in an N2 Session Management (SM) information container or is carried outside the N2 SM information container.

5-6. (canceled)

7. The method of claim 4, further comprising:
transmitting, to a Multicast/Broadcast User Plane Function (MB-UPF) in response to receiving the indication, a session modification request to release a Downlink (DL) tunnel corresponding to the NG-RAN, the session modification request containing the ID of the MBS session and tunnel information.

8. The method of claim 2, further comprising, in response to receiving the indication of the NG-RAN:
transmitting, to the AMF, a request to restore the MBS session towards the NG-RAN, the request containing the ID of the NG-RAN and the ID of the MBS session.

9. The method of claim 8, wherein:
the request is an MBS Broadcast Context Update request or an MBS Broadcast Context Create request; or
the request is an MBS Broadcast Context Update request or an MBS Broadcast Context Create request and wherein the request further contains an indication of MBS session restoration.

10. The method of claim 8, wherein the request further contains an indication of MBS session restoration.

11. The method of claim 8, further comprising:
receiving, from the AMF, a response to the request to restore the MBS session or an MBS broadcast context status notify request, the response or the MBS broadcast context status notify request containing the ID of the NG-RAN; or
receiving, from the AMF, a response to the request to restore the MBS session or an MBS broadcast context status notify request, the response or the MBS broadcast context status notify request containing the ID of the NG-RAN, wherein the response or the MBS broadcast context status notify request further contains tunnel information of a Downlink (DL) tunnel for the MBS session, and wherein the method further comprises:
maintaining a mapping between the ID of the NG-RAN and the tunnel information of the DL tunnel.

12-25. (canceled)

26. A method in an Access and Mobility Management Function (AMF) comprising:
receiving, from a Multicast/Broadcast Session Management Function (MB-SMF), a request to restore a Multicast/Broadcast Service (MBS) session towards a Next Generation-Radio Access Network (NG-RAN), the request containing an identifier, (ID), of the NG-RAN.

27. The method of claim 26, wherein the request further contains an ID of the MBS session.

28. The method of claim 27, further comprising, prior to said receiving, in a start or update procedure for the MBS session:
transmitting, to the MB-SMF, a message containing the ID of the NG-RAN,
wherein the ID of the NG-RAN is contained in an N2 Session Management (SM) information container.

29. The method of claim 26, further comprising, prior to said receiving, in a start or update procedure for the MBS session:
transmitting, to the MB-SMF, a message containing the ID of the NG-RAN,
wherein the ID of the NG-RAN is carried outside an N2 Session Management (SM) information container.

30. The method of claim 29, further comprising:
receiving, from the NG-RAN, another message containing tunnel information of a Downlink (DL) tunnel corresponding to the NG-RAN,
wherein the another message further contains the tunnel information, in which the tunnel information is contained in the N2 SM information container.

31. The method of claim 26, further comprising, subsequent to receiving the request to restore the MBS session:
transmitting, to the NG-RAN, a request to set up resources for the MBS session;
receiving, from the NG-RAN, a response to the request to set up resources for the MBS session; and
transmitting, to the MB-SMF, a response to the request to restore the MBS session or an MBS broadcast context status notify request, the response or the MBS broadcast context status notify request containing the ID of the NG-RAN.

32. The method of claim 26, further comprising, prior to receiving the request to restore the MBS session:
transmitting, to the MB-SMF, the ID of the NG-RAN, an indication of restart of the NG-RAN and the ID of the MBS session; or
transmitting, to the MB-SMF, the ID of the NG-RAN, an indication of restart of the NG-RAN and the ID of the MBS session, wherein the ID of the NG-RAN, the indication of restart of the NG-RAN, and the ID of the MBS session are contained in an MBS broadcast context status notify request.

33. (canceled)

34. The method of claim 32, further comprising, prior to transmitting the indication of restart of the NG-RAN:
receiving, from the NG-RAN, an NG setup request or NG reset request indicating the restart of the NG-RAN; and
determining the ID of the MBS session associated with the NG-RAN.

35. The method of claim 29, further comprising:
receiving, from the NG-RAN, another message containing tunnel information of a Downlink (DL) tunnel or a transport network Internet Protocol (IP) address corresponding to the NG-RAN,
wherein the message further contains the tunnel information or the transport network IP address, and the tunnel information or the transport network IP address is contained in the N2 SM information container, or
wherein the message further contains the tunnel information or the transport network IP address, and the tunnel information or the transport network IP address is contained in the N2 SM information container and wherein the transport network IP address is an IP address for user plane path management.

36-37. (canceled)

38. The method of claim 26, wherein;
the request to restore the MBS session is an MBS Broadcast Context Update request or an MBS Broadcast Context Create request; or
the request to restore the MBS session is an MBS Broadcast Context Update request or an MBS Broadcast Context Create request and wherein the request to restore the MBS session further contains an indication of MBS session restoration.

39-55. (canceled)

56. A network node, comprising:
a communication interface;
a processor; and
a memory, the memory comprising instructions which, when executed by the processor, cause the network node when implemented as an Access and Mobility Management Function (AMF) to:
receive, from a Multicast/Broadcast Session Management Function (MB-SMF), a request to restore a Multicast/Broadcast Service (MBS) session towards a Next Generation-Radio Access Network (NG-RAN), the request containing an identifier (ID) of the NG-RAN.

57. (canceled)
